(19) United States
(12) Patent Application Publication
(10) Pub. No.: US 2026/0097557 A1
(43) Pub. Date: Apr. 9, 2026

(54) METHOD FOR THE VOLUMETRIC PRINTING THROUGH HOLOGRAMS USING HIGH WAVELENGTH RADIATION

(71) Applicant: INNOMAQ 21,S.L., Madrid (ES)

(72) Inventor: Isaac VALLS ANGLÉS, Madrid (ES)

(73) Assignee: Innomaq 21, Sociedad Limitada, Madrid (ES)

(21) Appl. No.: 19/115,105

(22) PCT Filed: Sep. 27, 2023
(86) PCT No.: PCT/EP2023/076786

§ 371 Date: Mar. 25, 2025

(30) Foreign Application Priority Data
Sep. 27, 2022 (ES) P202230831

(51) Int. Cl. B29C 64/153; B29C 64/129; B29C 64/264; B29C 64/393; B33Y 10/00; B33Y 50/02

(52) U.S. Cl. CPC B29C 64/153; B29C 64/129; B29C 64/264; B29C 64/393; B33Y 10/00; B33Y 50/02

(57) ABSTRACT

The present invention relates to volumetric additive manufacturing (3D printing) through holograms for manufacturing high performance components with high mechanical properties at low cost and with low environmental impact from a wide variety of different materials, including but not limited to metallic materials, ceramic materials, polymeric materials and/or combinations thereof. The invention further relates to the apparatus used, and to the printed components.

### FIELD OF THE INVENTION

The present invention relates to volumetric additive manufacturing (3D printing) through holograms, and is particularly suitable for the manufacture of geometrically complex components from a wide variety of different materials, including but not limited to metallic materials, ceramic materials, polymeric materials and/or combinations thereof.

### SUMMARY

The present invention relates to a method for the volumetric printing through holograms, to the apparatus used, and to the printed components. This invention is particularly suitable for manufacturing high performance components with high mechanical properties at low cost and with low environmental impact. The method may also help to reduce the deformation of the printed components, resulting in components with more regular geometries.

### DESCRIPTION OF THE DRAWINGS

FIG. 1. Overview of an example of a volumetric printing apparatus.

FIG. 2. Detail of the hologram printing.

FIG. 3. Details of the high wavelength radiation constraining elements.

FIG. 4. a) One slices of a plane within the powder bed of example 1 depicting electromagnetic field intensity in a colour scale, the two pictures corresponding to different control variables values. b) example of simulation of extremely enhanced electromagnetic field wave stopping.

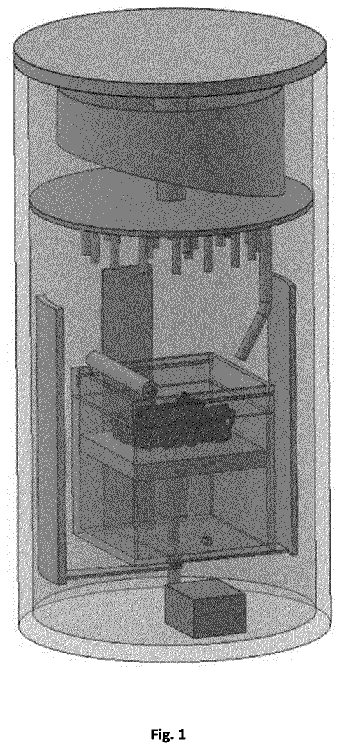

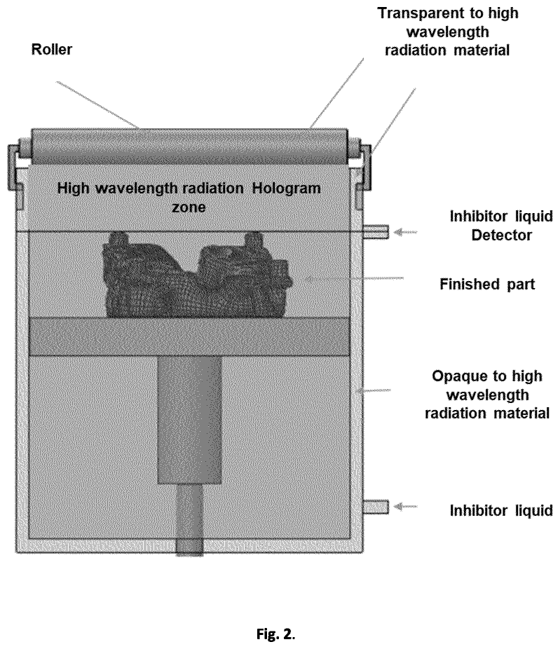

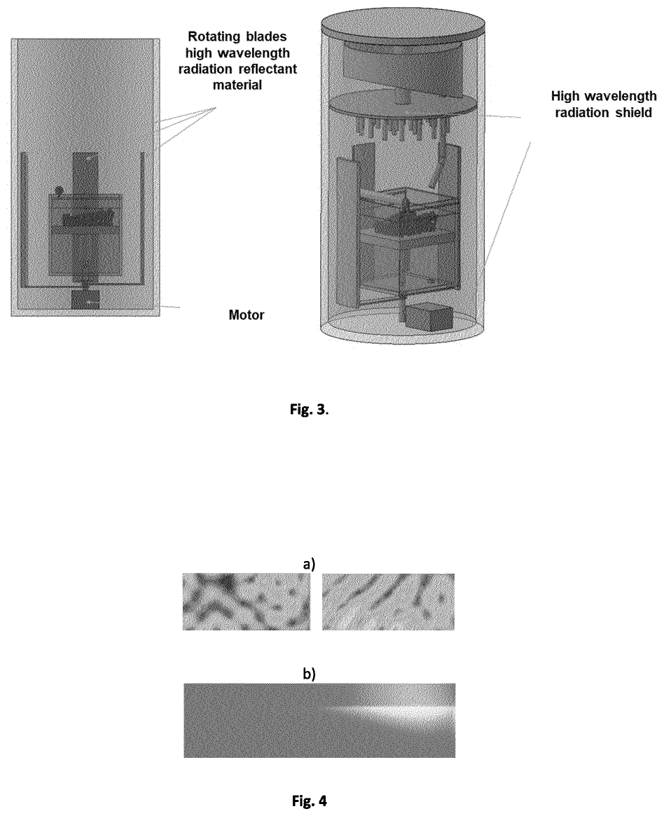

### STATE OF THE ART

Traditional powder bed AM technologies use additive layering to build three-dimensional (3D) components from layers of powder, with each layer forming a two-dimensional (2D) part of the component, so that successive layers are used to build up the 3D component.

### DETAILED DESCRIPTION

When producing highly geometrically complex shapes with high mechanical properties at low cost, conventional machining processes achieve good mechanical properties but with severe limitations when it comes to geometrical flexibility (especially for internal features), and geometrical complexity comes at a high cost. In addition, the environmental impact is highest due to the low resource efficiency. Other manufacturing technologies such as for example, traditional powder bed AM technologies, achieve decent mechanical properties and have good geometric flexibility, with some limitations on internal features (e.g., voids, cooling channels, . . . ) and the need to use support elements, but at a very high cost and environmental impact.

The inventor has surprisingly found that it is possible to manufacture components using a volumetric printing through holograms method that selectively consolidates at least part of a powder bed when exposed to a “proper radiation” (as defined in this document), thereby improving the efficiency and reducing the cost per component manufactured. The purpose of exposing the powder bed, or at least part of it, to the “proper radiation” is to consolidate selected areas of the powder bed, thereby creating a three-dimensional object directly, and not in a layered fashion. When achievable, such a system would provide extremely fast manufacturing of components, orders of magnitude faster than current powder bed (SLM, SLS, . . . ) or even DeD/WAAM systems with the same or even enhanced design flexibility. To achieve this objective, the “proper radiation” (as defined in this document) has to penetrate a loose material (powder bed) and selective consolidate part of it. That is, the material to be consolidated has to act as transparent to the “proper radiation” to be able to reach any desired sub-surface particle and then some event has to take place to consolidate only the areas of interest. This should be achieved in a way in which high precision is achieved and little energy and time are wasted. WO2021165545A1 describes a very ingenious system to achieve consolidation of all powder in the shape of interest, by constraining the powder to the desired shape with a shaped container/mound and then applying a wavelength that volumetrically heats all powder at once (matching wavelength to voids between powder particles) which implies the usage of rather small powder particles and high wavelength radiation (as defined in this document). Since the shape is provided by the container very fine details can be obtained, and since only the required powder is inside the radiation chamber, conditions can be attained for very efficient usage of the radiation. One drawback is that every time a mould/container has to be manufactured and afterwards eliminated. Another challenge is that high wavelength radiation tends to form patterns of white different electromagnetic field intensity which does not make uniform heating easy, WO202165545A1 provides several ways to overcome this challenge. An alternative way would be to turn the challenge into an advantage and take advantage of this field intensity inhomogeneity, and create a hologram where the areas of high field intensity would coincide with the intended shape (for example trough the selective trapping/modulation of the radiation trough a “filter”/high wavelength radiation hologram generator that would generate the holographic image of high intensity points in the chamber where the powder is located. In an embodiment, the radiation is selectively modulated through a filter and/or a high wavelength radiation hologram generator that generates the holographic image of high intensity points in the chamber where the powder bed is located. Unless otherwise indicated, the feature “high wavelength” is defined throughout this document in the form of different alternatives that are explained in detail below. In different embodiments, a high wavelength radiation is a radiation with a wavelength of 0.00008 cm or more, 0.0006 cm or more, of 0.0012 cm or more, of 0.06 cm or more, of 0.2 cm or more, of 1.15 cm or more, of 6 cm or more, and even of 11 cm or more. For certain applications, the wavelength should be limited. In different embodiments, a high wavelength radiation is a radiation with a wavelength of 59 cm or less, 19 cm or less, of 14 cm or less, of 9 cm or less, of 4 cm or less, of 0.9 cm or less, of 0.04 cm or less and even of 0.09 cm or less. All the embodiments disclosed above can be combined among them in any combination provided that they are not mutually exclusive, for example, in an embodiment, a high wavelength radiation is a radiation with a wavelength between 0.00008 and 59 cm. For some applications, it may be advantageous to calculate the high intensity points as a percentage of the mean radiation intensity of all the points in the powder bed. In different embodiments, a high intensity point is a point with a radiation field intensity at least 20% higher, at least 55% higher, at least 110% higher, at least 220% higher, at least 55% higher, and even at least 1010% higher than the mean radiation intensity of all the points in the powder bed. The inventor has found that in some embodiments, it may be desirable to disregard points where the radiation field intensity is below a certain value. In different embodiments, the points with a radiation field strength below 99 V/m, below 25 V/m, below, 9 V/m, below 4 V/m, and even below 0.8 V/m are not used to calculate the mean radiation intensity. For some applications, it may be preferable to use the absolute values. In different embodiments, a high intensity point is a point with a radiation field intensity of 0.8 V/m or more, 110 V/m or more, 220 V/m or more, 330 V/m or more, 620 V/mor more, and even 1010 V/m or more. All the embodiments disclosed above can be combined among them in any combination provided that they are not mutually exclusive, for example, in an embodiment, the radiation is selectively modulated through a filter and/or a radiation hologram generator with a wavelength between 0.00008 and 59 cm; or for example in another embodiment, a filter and/or a radiation hologram generator with a wavelength between 0.00008 and 59 cm generates a holographic image of points with a radiation field intensity at least 20% higher than the mean radiation intensity of all the points in the powder bed, wherein the points in the powder bed exposed to a radiation field intensity of 0.8 V/m or less are excluded to calculate the mean radiation intensity, this holographic image of points being generated in the chamber where the powder bed is located; or for example in another embodiment, a filter and/or a radiation hologram generator with a wavelength between 0.00008 and 59 cm generates a holographic image of points with a radiation field intensity of 0.8 V/m or more, this holographic image of points being generated in the chamber where the powder bed is located. Such system would be constrained to rather simple geometries with little accuracy placement of features due to “diffraction phenomena within the powder bed, rough surfaces (even a control volume of 1 mm³ would be very challenging to achieve) and in most cases would be associated to substantial energy waste with its negative impact on sustainability. It has surprisingly been seen by the inventor that a very high precision can be achieved, with very efficient usage of energy in an extremely fast manufacturing speed through the generation of a plurality of high field intensity holograms which are radiated to the powder bed sequentially and where each one of those holograms does not coincide with the totality of the component to be manufactured, but the sequential radiation with the different high field intensity hologram patterns does deliver the component to be manufactured. At first sight, this system might seem energetically inefficient since some points of the manufactured component will coincide with high intensity field points in the sequence of holograms more than once, and extremely laborious in the selecting of working conditions for the generation of an optimized hologram sequence. In an embodiment, the sequence of holograms is generated by selecting the sequence of control variables. The first point has been surprisingly seen not to be relevant at all, that is the efficiency in the usage of energy is indeed very high. The second point only requires powerful computing with any of the multiple possible algorithms and even far less if Artificial Intelligence is employed. The method explained in this document provides components with even slightly higher design flexibility than WO202165545A1, which is orders of magnitude higher than any system which would operate with fix holograms for the entire geometry and has a similar speed to both, and surprisingly a similar energy efficiency to WO202165545A1 and much higher efficiency than any system with fixed hologram. Also, in the case of higher melting point materials (like metals, ceramics and their composites) it is generally more energetically efficient to produce a low temperature bonding instead of joining the powder particles trough melting or sintering at the high field intensity points and after the shaping step subjecting the manufactured components to some treatment which comprises diffusion of this higher melting point particles. For such a low temperature bonding it is often interesting to have some intermediary polymeric material in powder or even in liquid form and it is also often helpful the usage of glowing” materials which increase their temperature when exposed to the high field intensity of the high wavelength radiation and in the case of liquid polymer also polymerization initiation particles (and eventually even polymerization terminators) which help initiate/terminate the local polymerization of the liquid polymer into solid. In an embodiment, the consolidation of part of the powder in the powder bed occurs after the second exposition of the powder bed to the radiation. The inventor has seen that in some embodiments it is very interesting to execute hologram strategies where a hologram has a short enough pulse duration or the intensity of the high field intensity points is not high enough so that consolidation does not take place but a susceptibility to consolidation is developed, so that if that point is exposed a second time to a sufficiently high field intensity, then consolidation does take place. In an embodiment, when the duration of the exposition of a point of the powder bed to a particular hologram is short enough or when that point is not exposed to a high enough radiation field strength, then the consolidation does not occur, but when that point is exposed a second time to a sufficiently high radiation field strength, then consolidation occurs. In such a way, more complex holograms can be employed and surprisingly in many cases despite the requirement of two pulses (points to consolidate belonging at least to two holograms) a faster consolidation rate can be achieved because every hologram comprises many more points with high enough intensity field. The term “pulse” mostly refers to the exposition duration of a particular hologram. Also, the amount of available configurations (or potential holograms) that can be used for a particular geometry is increased exponentially. For further flexibility, the system can be configured, and even more so when “glowing” materials are used (some non-limiting examples of glowing materials are described later in this document), so that the exposition to two pulses (two holograms having a high enough intensity field at the point of interest) must take place within a certain time limit to lead to consolidation (for example, when consolidation is triggered by the reaching of a certain temperature, pulses can be made “short” enough or field intensities of high field intensity points, low enough so that temperature is increased on the points of interest, when exposed to the first hologram with high field intensity at the point of interest, but not enough to lead to consolidation, the risen temperature will tend to go back to its original value so that only a second exposition of the point of interest before it has sufficiently cooled down again will lead to consolidation. For some applications, it may be advantageous to use of more than one radiation pulse to consolidate a given point. In an embodiment, 2 pulses are required to consolidate a given point. In an embodiment 2 pulses within the right time are required to consolidate a given point. The same strategy can be employed for a configuration requiring a plurality of points to consolidate, each additional point increasing exponentially the number of available holograms. In an embodiment, 3 pulses are required to consolidate. In an embodiment, 3 pulses within the right time are required for consolidation to take. For some applications, it may be advantageous to use 3 or more radiation pulses to consolidate a given point. In different embodiments, 3 pulses or more, 4 pulses or more, 5 pulses or more, and even 10 pulses or more are required to consolidate. For some applications of the method, a limited number of pulses may be preferable. In different embodiments, 1000 pulses or less, 90 pulses or less, 45 pulses or less, 19 pulses or less, and even 9 pulses or less are required to consolidate. For some applications of the method, it may be desirable to apply the pulses for a right time. In different embodiments, 3 pulses or more, 4 pulses or more, 5 pulses or more, and even 10 pulses or more within the right time are required for consolidation to take place. For some applications, it may be advantageous to limit the number of pulses. In different embodiments, 1000 pulses or less, 90 pulses or less, 45 pulses or less, 19 pulses or less, and even 9 pulses or less within the right time are required for consolidation to take place. All the embodiments disclosed above can be combined among them and with any other embodiment disclosed in this document in any combination provided that they are not mutually exclusive, for example, in an embodiment, the number of pulses required to consolidate are between 3 and 1000; or for example in another embodiment, the method comprises the use of between 3 and 1000 pulses within the right time to produce consolidation in a point of the powder bed. In some embodiments, there is a continuous transition from one hologram to the next, and thus counting the number of holograms has little meaning, it mostly counts the time x Intensity value every point has been exposed to determine consolidation-]. In an embodiment, one pulse (exposition to high intensity field trough just one hologram) is insufficient for whole consolidation but sufficient to increase consolidation susceptibility because the exposition to radiation time of the hologram is too short. In an embodiment, one pulse (exposition to high intensity field trough just one hologram) is insufficient for whole consolidation but sufficient to increase consolidation susceptibility because the field intensity of the high intensity points is too low. In fact, it has been surprisingly observed by the inventor that this strategy can be employed to increase precision and durability of certain elements. That is so, because the change in intensity field is normally not discontinuous, and thus it is possible to accurately adjust the points to be consolidated by making sure the amount of radiation received is sufficient to trigger consolidation trough the continuous variation of control variables thus providing a continuous transition from hologram to the next hologram without having to interrupt the radiation exposure. This tends to increment the computational power required to attain the variation sequence of all control variables to make sure all belonging to the component to be manufactured receive enough radiation while the others do not (exceptionally it is also allowed to consolidate points that do not belong to the component to be manufactured, especially if the extra burden to recycle such points is compensated by the increased ease in determining the full hologram sequence, especially when it is a continuous sequence). In an embodiment, the method method comprises the use of a sequence of holograms. In an embodiment, the method comprises the use of a sequence of holograms which is generated by selecting the sequence of control variables. Surprisingly, one of the most effective configurations is based on a continuous transition from hologram to hologram (continuous variation of the control variables) with speed variation in the change of hologram (would be equivalent to a longer pulse) but which is not rationalized in terms of pulse length of different holograms, but rather every point in the powder bed is assigned a consolidation counter and behavioural models are assigned to each point so that according to the conditions encountered by the point during a hologram continuous variation sequence, there is a permanent value assigned to the point which expresses how far away it is from consolidation from 0% to 100%, the model takes into account amongst others how much radiation the point has received, how much time it has had to evacuate heat with the surroundings, what is the effect of surrounding points also evacuating heat, etc. In an embodiment, the method comprises the use of machine learning trained with a transformation from the input vector, containing all the possible combinations of the control variables and the scalar output, which is the degree of consolidation map comprising the value for each point in the powder bed, to generate the sequence of values for each control variable that generates the sequence of holograms. In an embodiment, the method comprises the use of machine learning trained with a transformation from the input vector, containing all the possible combinations of the control variables and the scalar output, which is the radiation field intensity map comprising the value for each point in the powder bed, to generate the sequence of values for each control variable that generates the sequence of holograms. This map of consolidation becomes the “scalar” output for the machine learning system and is obtained by simulation during the supervised training of the machine learning system, as most cases in this document the ‘input vector’ is constituted by the particular combinations of control variable values. Then the transformation has to be inverted, and as previously described also here clustering of ‘input vectors’ is often helpful. In an embodiment, the machine learning system takes into account that the points of the powder bed belonging to the components to be manufactured have to reach a 100% consolidation value and the points of the powder bed which do not coincide with any component to be manufactured stay always below 50% consolidation value. In an embodiment, the training of the machine learning system, the transformation is inverted. In an embodiment, clustering of the input vectors is applied to facilitate the inversion of the transformation. In an embodiment, the method comprises modelling the consolidation level reached by every point in the powder bed. In an embodiment, the method comprises the use of a machine learning system to provide the control variable variation sequence, the machine learning system comprising the modelling of the consolidation level reached by every point in the powder bed. In an embodiment, the method comprises the use of a machine learning system to provide the time variation of each of the control variables, the machine learning system comprising the modelling of the consolidation level reached by every point in the powder bed. In an embodiment, the method comprises modelling the temperature level reached by every point in the powder bed. In an embodiment, the method comprises the use of a machine learning system to provide the control variable variation sequence, the machine learning system comprising the modelling of the temperature level reached by every point in the powder bed. In an embodiment, the method comprises the use of a machine learning system to provide the time variation of each of the control variables, the machine learning system comprising the modelling of the radiation accumulated energy level reached by every point in the powder bed. In an embodiment, the method comprises modelling the radiation accumulated energy level reached by every point in the powder bed. In an embodiment, the method comprises the use of a machine learning system to provide the control variable variation sequence, the machine learning system comprising the modelling of the radiation accumulated energy level reached by every point in the powder bed. In an embodiment, the method comprises the use of a machine learning system to provide the time variation of each of the control variables, the machine learning system comprising the modelling of the radiation accumulated energy level reached by every point in the powder bed. In an embodiment, the modelling comprises the amount of energy directly received by the point and the heat transmission to and from surrounding points. In an embodiment, the modelling is used in the simulation of such consolidation level for each point in the powder bed as a function of any value combination in the control variables and in turn using this simulation during the supervised training of the machine learning system. In an embodiment, in the machine learning system the input vector is constituted by the particular combinations of control variable values where clustering of input vectors is employed to favour the inversion of the transformation. In an embodiment, the machine learning system takes into account that the points of the powder bed belonging to the components to be manufactured have to reach a 100% consolidation value and the points of the powder bed which do not coincide with any component to be manufactured stay always below 50% consolidation value. This system, in turn, can be used for layered manufacturing of larger objects, but each layer is already a true three-dimensional object, rather than merely the extrusion of a planar image (e.g., an ultra-thin layer), as is traditionally the case in layered manufacturing. The present disclosure therefore provides a volumetric printing method for manufacturing three-dimensional components through holograms, which in some cases may be particularly suitable for large powder layers, although the printing method may be applied to powder layers of any thickness. In some embodiments, the method may be used to build up the component from selectively consolidated powder layers, while in other embodiments it may be possible to manufacture the entire component at once. In an embodiment, the method for the additive manufacturing of components, comprises the steps of:
Step 1: providing a powder bed comprising at least one layer of powder;
Step 2: exposing at least part of the powder bed to radiation to consolidate only part of the powder in the powder bed;
Step 3: optionally, providing an additional layer of powder adjacent to the previously consolidated or at least partially consolidated layer of powder to form successive powder layers of the powder bed;
Step 4: optionally, repeating step 2;
Step 5: optionally, repeating steps 3 and 4 until the component is completely additively manufactured; and
Step 6: separating the consolidated or partially consolidated powder from the unconsolidated powder in the powder bed.

The method disclosed above may comprise other additional steps besides the above steps, some of which are described in more detail later.

Throughout this document, the term “adjacent” should be understood as having points in contact with the previously provided layer of powder and/or with the powder bed, where the layers can be in any position, whether vertical, horizontal, or any other position. Thus, the term “adjacent” includes layers of powder provided above, partially above, on top of, partially on top of, below, partially below, next to and/or partially next to the previously consolidated or at least partially consolidated layer of powder and/or the powder bed. In an embodiment, in step 3, the additional layer of powder is provided at least partially on top of the previously consolidated or at least partially consolidated layer of powder. In another embodiment, in step 3, the additional layer of powder is provided on top of the previously consolidated or at least partially consolidated layer of powder. In another embodiment, in step 3, the additional layer of powder is provided at least partially below the previously consolidated or at least partially consolidated layer of powder. In another embodiment, in step 3, the additional layer of powder is provided at least partly next to the previously consolidated or at least partially consolidated layer of powder.

In an embodiment, the method is performed in a chamber in which the three-dimensional component is additively manufactured. The chamber may be configured to have a powder bed comprising at least one layer of powder disposed therein. For example, the powder may be deposited on a powder holder (e.g., a platform, build platform, build plate, printing bed, tank, container, . . . ) located in the chamber, which may be designed to receive and support the powder. Deposition may be performed by a powder deposition system which controls the amount of powder supplied to form a powder layer in a powder bed (i.e., the powder bed comprises at least one powder layer), and which may include one or more powder dispensers. For example, the powder deposition system may comprise a spreader (e.g., a roller, blade, . . . ) for spreading the powder in a controlled manner. The powder may be received, for example, from one or more powder supply devices, including at least a powder storage unit (i.e., a container, tank, hopper, vessel or other receptacle that can act as a reservoir) configured to store the powder. Additionally, in certain embodiments, the deposition system may include at least one liquid dispenser configured to selectively dispense a liquid material (e.g., a polymer, binder, resin, fusing agent, cross-linking agent, additive . . . ) to form a volume of the powder bed comprising powder and liquid material. As previously disclosed, in most embodiments, the components may be built up in layers, and therefore after performing the step 2, an additional layer of powder may be added adjacent to the previously consolidated or at least partially consolidated layer (i.e., in some embodiments, the steps 3 to 5 of the method are mandatory). In some embodiments, the powder bed may be moved, for example, in a vertical downward direction, as an additional layer of powder is deposited adjacent to the previously consolidated or at least partially consolidated layer of powder in the powder bed. For some applications of the method, it may also be advantageous to use a rotatable powder holder, so that it may be possible to rotate the powder bed before, during and/or after any of the steps of the method are performed. For some applications, particularly where high temperatures are used to consolidate the powder, but also where low temperatures are used (e.g., below sintering or melting temperatures), it may be advantageous to pre-heat the powder bed provided, or at least part of the powder layers in the powder bed, in a controlled manner, which may help to avoid the rapid level of temperature increase and in some cases may improve the properties of the manufactured components. In an embodiment, the method comprises preheating the powder bed. In another embodiment, the method comprises maintaining the powder bed heated. In most applications of the method, the separation of the unconsolidated powder may advantageously be performed after the entire component is additively manufactured. However, in certain particular applications of the method, the unconsolidated powder may be separated from the consolidated or partially consolidated powder before an additional layer of powder is added. In an embodiment, step 6 is performed after each exposure of the powder bed to the radiation and prior to providing an additional layer of powder in step 3. Throughout this document, consolidation should be understood as a sufficiently strong bond between powder particles to allow removal of loose powder without breaking the bond between the particles. In most cases, consolidation may be effected at a temperature below the sintering or melting temperature. In this respect, the inventor has found that consolidation at low temperatures may be particularly advantageous, although in certain particular embodiments consolidation may also be effected at high temperatures (e.g. above the sintering and/or melting temperature). In an embodiment, consolidation takes place at a temperature below the temperature at which sintering or melting occurs. However, in certain particular embodiments, consolidation may comprise a partial adhering and/or bonding of particles by sintering and/or melting. In many applications, care must be taken to ensure open porosity connectivity of the non-consolidated areas within the printed part. In some embodiments, particularly in the manufacture of some polymeric or at least partially polymeric components, it may be advantageous to manufacture components from polymer layers in liquid form rather than using powder layers, so that instead of providing one or more layers of powder, the method comprises providing one or more layers of polymer in liquid form. In these particular embodiments, the term “powder bed”, may be replaced by “polymer bed”, the term “layer of powder” may be replaced by “layer of polymer in liquid form” and the term “consolidation” may be replaced by “polymerization or curing”. In another embodiment, the method for the additive manufacturing of components, comprises the steps of:
Step 1: providing a polymer bed comprising at least one layer of polymer in liquid form;
Step 2: exposing at least part of the polymer bed to radiation to cure only part of the polymer in the polymer bed;
Step 3: optionally, providing an additional layer of polymer in liquid form adjacent to the previously cured or at least partially cured layer of polymer to form successive layers of the polymer bed;
Step 4: optionally, repeating step 2;
Step 5: optionally, repeating steps 3 and 4 until the component is completely additively manufactured; and
Step 6: separating the cured or partially cured polymer from the uncured polymer in the polymer bed.

For some applications, the use of a polymer comprising metallic and/or ceramic particles may be advantageous, so that the polymer is mixed with ceramic and/or metallic particles to form a slurry and the method comprises the use of layers of slurry instead layers of powder. In an embodiment, the polymer is mixed with ceramic and/or metallic particles to form a slurry. In these particular embodiments, the term “powder bed”, may be replaced by “slurry bed”, the term “layer of powder” may be replaced by “layer of slurry” and the term “consolidation” may be replaced by “polymerization or curing”. In another embodiment, the method for the additive manufacturing of components, comprises the steps of:
Step 1: providing a slurry bed comprising at least one layer of slurry;
Step 2: exposing at least part of the slurry bed to radiation to cure only part of the layer of slurry in the slurry bed;
Step 3: optionally, providing an additional layer of slurry adjacent to the previously cured or at least partially cured layer of slurry to form successive layers of the slurry bed;
Step 4: optionally, repeating step 2;
Step 5: optionally, repeating steps 3 and 4 until the component is completely additively manufactured; and
Step 6: separating the cured or partially cured slurry from the uncured slurry in the slurry bed.

The inventor has found that for some applications of the method, it may be particularly advantageous to constrain the part of the powder consolidated in step 2 to the uppermost layer of powder added, whereas for other applications, it may be preferable to selectively consolidate at least part of the powder in more than one layer. In an embodiment, the part of the powder exposed to the radiation in step 2 is constrained to the uppermost layer of powder added. In another embodiment, the part of the powder exposed to the radiation in step 2 is constrained to the two uppermost layers of powder added. In another embodiment, the part of the powder exposed to the radiation in step 2 is constrained to some, but not all, of the plurality of powder layers in the powder bed. For example, in relation to the exposure of the powder bed to the radiation, the radiation patterns may be created to control which parts of the powder in the powder bed receive the radiation dosage. The inventor has found that for some applications of the method, it may be particularly advantageous to constrain the part of the powder exposed to the radiation in step 2 to the uppermost layer of powder added, whereas for other applications of the method, it may be preferable to ensure that the part of the powder exposed to the radiation is not constrained to the uppermost layer of powder added. In an embodiment, the part of the powder that is consolidated in step 2 is constrained to the uppermost layer of powder added. In another embodiment, the part of the powder that is consolidated in step 2 is constrained to the two uppermost layers of powder added. In another embodiment, the part of the powder that is consolidated in step 2 is constrained to some, but not all, of the plurality of powder layers in the powder bed. For certain applications, it may be advantageous to use a radiation barrier, at least in certain areas of the powder bed. In an embodiment, step 2 comprises consolidating at least part of the additional layer of powder provided with at least part of the at least partly consolidated layer of powder. The inventor has found that for some applications, it may be particularly advantageous to maintain certain zones in the powder bed where consolidation does not take place. In an embodiment, when applying step 2, there is a zone of the powder bed where the radiation field strength is below the radiation field strength that produces consolidation, so that no consolidation takes place. In an embodiment, the zone in the powder bed where no consolidation takes place coincides with the previously consolidated or at least partially consolidated layers of powder. In an embodiment, the radiation field strength is below the radiation field strength that produces consolidation, because the radiation is substantially stopped or slowed down. In an embodiment, consolidation is impeded in zones where at least part of the powder bed was previously consolidated, through the use of magnetic fields. In an embodiment, the radiation in the zones of the powder bed where consolidation does not take place is stopped or slowed down using an extremely enhanced magnetic field. In an embodiment, the radiation is stopped or slowed down using one or more microwave one-way waveguides. In different embodiments, an extremely enhanced magnetic field is a magnetic field with an amplitude of 110 V/m or more, 220 V/m or more, 1300 V/m or more, 12000 V/m or more, and even 56000 V/m or more. For some applications, it may be desirable to maintain the amplitude below a certain value. In different embodiments, an extremely enhanced magnetic field is a magnetic field with an amplitude of 10⁸ V/m or less, 10⁷ V/m or less, 0.9 10⁶ V/m or less, and even 9000 V/m or less. All the embodiments disclosed above can be combined among them and with any other embodiment disclosed in this document in any combination provided that they are not mutually exclusive, for example, in an embodiment, an extremely enhanced magnetic field is a magnetic field with an amplitude between 110 and 10⁸ V/m or less.

The volumetric printing method disclosed in this document may be particularly suitable for the manufacture of metallic components or at least partially metallic components (such as for example, but not limited to, metal matrix composites). In an embodiment, the method comprises the manufacture of metal or metal containing components from powders or powder mixtures comprising at least a metal or an alloy in powder form. Different metals and/or alloys in powder form may advantageously be used to manufacture a wide variety of metal comprising components. In an embodiment, the powder bed comprises at least a metal or an alloy. The powder employed may be a single powder or a powder mixture, which may further comprise other additional substances or materials. For some applications, it may be advantageous to provide a powder bed further comprising a polymer, which may be in solid and/or liquid form. In different embodiments, the powder bed comprises a polymer in an amount of less than 79% by volume, less than 59% by volume, less than 49% by volume, less than 45% by volume less than 35% by volume, less than 25% by volume, less than 15% by volume, and even less than 5% by volume in respect of the total volume of the powder bed, and a metallic powder. Some examples of metals and alloys that may be particularly suitable include, but are not limited to, iron, iron based alloy, steel, stainless steel, nickel, nickel based alloy, copper, copper based alloy, chromium, chromium based alloy, cobalt, cobalt based alloy, molybdenum, molybdenum based alloy, manganese, manganese based alloy, aluminium, an aluminium based alloy, tungsten, tungsten based alloy, titanium, titanium based alloy, lithium, lithium based alloy, magnesium, magnesium based alloy, niobium, niobium based alloy, zirconium, zirconium based alloy, silicon, silicon based alloy, tin, tin based alloy, tantalum, tantalum based alloy, and/or mixtures thereof. In an embodiment, the powder bed comprises at least one of the metals or metal alloys described above in powder form. However, the composition of the powder bed is not limited to the metals or alloys described above. In some embodiments, the presence of other components in the powder bed may be advantageous. These substances or materials may be added to the powder bed before, after and/or simultaneously with the metallic powder (or powders). Some examples of substances or materials that may be particularly suitable include, but are not limited to, organic materials, polymers, polymeric materials, binders, resins, fluxes, fusing agents, dry coaters, fluidizers, surface functionalized nanoparticles, lubricants, additives, inhibitors, catalytic particles, nanoparticle additives, graphite, ceramic materials, reinforcement particles, ceramic particles, whiskers, graphene, nanotubes, carbon nanotubes, and/or mixtures thereof. In this regard, the inventor has found that for some applications it may be particularly advantageous to provide a powder bed which further comprises a polymer in liquid form. In an embodiment, the powder bed comprises a polymer in liquid form. For some applications, the use of at least partially coated powders may also be advantageous. The inventor has found that for some applications, it may be particularly advantageous to add catalytic particles, so that when the radiation field strength is high enough, these catalytic particles may help to absorb the radiation and to raise the temperature [of the powder bed, where they are located]. In an embodiment, the powder bed comprises catalytic particles that raise their temperature when exposed to the radiation. In certain applications, where a liquid polymer is used, these catalytic particles may produce polymerisation or curing of the polymer. In an embodiment, the polymer bed comprises catalytic particles that produce the curing of the polymer. For some applications, the use of a polymer comprising metallic and/or ceramic particles may be advantageous, so that the polymer is mixed with ceramic and/or metallic particles to form a slurry and catalytic particles are also added. In an embodiment, the slurry bed comprises catalytic particles that produce the curing of the slurry. For certain applications, the use of an inhibitor liquid may be also desirable. In an embodiment, the method comprises the use of an inhibitor liquid.

This volumetric printing method may also be particularly suitable for the manufacture of ceramic components or partially ceramic components (such as for example, but not limited to, ceramic matrix composites). The inventor has found that different ceramic materials in powder form may be advantageously used to manufacture a wide variety of ceramic comprising components. In an embodiment, the powder bed comprises at least a ceramic material. The powder may be a single powder or a powder mixture, which may further comprise other additional substances or materials. For some applications, it may be advantageous to provide a powder bed further comprising a polymer, which may be in solid and/or liquid form. In different embodiments, the powder bed comprises a polymer in an amount of less than 50% by volume, less than 45% by volume less than 35% by volume, less than 25% by volume, less than 15% by volume, and even less than 5% by volume in respect of the total volume of the powder bed, and a ceramic powder. Some examples of ceramic materials that may be particularly suitable include, but are not limited to, boron, crystalline boron, borides (e.g., chromium boride (CrB), chromium diboride (CrB₂), titanium diboride (TiB₂), zirconium diboride (ZrB₂), magnesium diboride (MgB₂), niobium diboride (NbB₂), hafnium diboride (HfB₂), tantalum diboride (TaB₂) . . . ), carbides (e.g., boron carbide (B₄C), chromium carbide (Cr₃C₂), molybdenum carbide (Mo₂C), silicon carbide (SiC), titanium carbide (TiC), tungsten titanium carbide (WTiC), vanadium carbide (VC), zirconium carbide (ZrC), hafnium carbide (HfC), tantalum carbide (TaC), niobium carbide (NbC) . . . ), nitrides (e.g., aluminium nitride (AlN), boron nitride (BN), silicon nitride (Si₃N₄), titanium carbonitride (Ti (C, N)), titanium nitride (TiN), zirconium nitride (ZrN), hafnium nitride (HfN), vanadium nitride (VN), tantalum nitride (TaN), niobium nitride (NbN) . . . ), oxides (e.g., yttrium oxide (Y₂O₃), boron oxide (B₂O₃), zin oxide (ZnO), zirconium oxide (ZrO₂) . . . ), silicon, silicides (e.g., molybdenum disilicide (MoSi₂), . . . ), titanates (e.g., barium titanate (BaTiO₃), strontium titanate (SrTiO₃), lead zirconate, titanate (PZT), . . . ) silicates (e.g., steatite, . . .), sialon, bioceramics, alumina, ferrite, porcelain and/or mixtures thereof. In an embodiment, the powder or powder mixture comprises at least a ceramic material selected from boron, crystalline boron, borides, carbides, nitrides, oxides, silicon, silicides, titanates, silicates, sialon, bioceramics, alumina, ferrite, porcelain, and/or mixtures thereof. In an embodiment, the powder bed comprises at least one of the ceramic materials described above. However, the composition of the powder bed is not limited to the ceramic materials described above. In some embodiments, the presence of other components in the powder bed may also be advantageous. These substances or materials may be added to the powder bed before, after and/or simultaneously with the ceramic powder (or powders). Some examples of substances or materials that may be particularly suitable include, but are not limited to, metals, alloys, organic materials, polymers, polymeric materials, binders, resins, fluxes, fusing agents, dry coaters, fluidizers, surface functionalized nanoparticles, lubricants, additives, inhibitors, catalytic particles, nanoparticle additives, graphite, reinforcement particles, whiskers, graphene, nanotubes, carbon nanotubes and/or mixtures thereof. In this regard, the inventor has found that for some applications, it may be particularly advantageous to provide a powder bed which further comprises a polymer in liquid form. In an embodiment, the powder bed comprises a polymer in liquid form. For some applications, the use of at least partially coated powders may also be advantageous. The inventor has found that for some applications, it may be particularly advantageous to add catalytic particles, so that when the radiation field strength is high enough, these catalytic particles may help to absorb the radiation and to raise the temperature [of the powder bed, where they are located]. In an embodiment, the powder bed comprises catalytic particles that raise their temperature when exposed to radiation. In certain applications, where a liquid polymer is used, these catalytic particles may produce polymerisation or curing of the polymer. For certain applications, the use of an inhibitor liquid may be also desirable. In an embodiment, the method comprises the use of an inhibitor liquid.

This volumetric printing method may also be particularly suitable for the manufacture of polymeric components or at least partially polymeric components (such as for example, but not limited to, polymer matrix composites). The inventor has found that different polymers (or polymeric materials) in powder form may be advantageously used to manufacture a wide variety of polymer comprising components. In an embodiment, the powder bed comprises at least a polymer. The powder may be a single powder or a powder mixture, which may further comprise other additional substances or materials. For some applications, the use of polymers in liquid form may be particularly advantageous. Some examples of polymers that may be particularly suitable for the manufacture of polymeric components or at least partially polymeric components include, but are not limited to, polyimide (PI), polycarbonate (PC), ether ketone (EK), polyethylene sulfide (PPS), polytetrafluorethylene (PTFE), polyethylene terephthalate (PET), polybutylene terephthalate (PBT), PA6, PA11, polyamide (PA), polyoxymethylene (POM), polymethylmethacrylate (PMMA), polystyrene (PS), acrylonitrile-butadiene-styrene (ABS), styrene-acrylonitrile (SAN), polypropylene (PP), polyethylene (PE), Polyamide-Imide (PAI), Polyethersulfone (PES), olyphenylsulfone (PPSU), polyetherimide (PEI), polysulfone (PSU), polyparaphenylene (PPP), polyether ether ketone (PEEK), polyetherketone (PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), PA6-3-T, PA46, polymethylpentene (PMP), polyphenylene ether (PPE), and/or mixtures thereof. In an embodiment, the powder bed comprises at least one of the polymers described above. However, the composition of the powder bed is not limited to the polymeric materials described above. In some embodiments, the presence of other components in the powder bed may also be advantageous. These substances or materials may be added to the powder bed before, after and/or simultaneously with the polymer. Some examples of substances or materials that may be particularly suitable include, but are not limited to, metals, alloys, binders, resins, fluxes, dry coaters, fluidizers, surface functionalized nanoparticles, lubricants, additives, inhibitors, catalytic particles, nanoparticle additives, graphite, ceramic materials, reinforcement particles, ceramic particles, whiskers, graphene, nanotubes, carbon nanotubes and/or mixtures thereof. The inventor has found that for some applications, it may be particularly advantageous to add catalytic particles, so that when the radiation field strength is high enough, these catalytic particles may help to absorb the radiation and to raise the temperature [of the powder bed, where they are located]. In an embodiment, the powder bed comprises catalytic particles that raise their temperature when exposed to radiation. In certain applications, where a liquid polymer is used, these catalytic particles may produce polymerisation or curing of the polymer. For certain applications, the use of an inhibitor liquid may be also desirable. In an embodiment, the method comprises the use of an inhibitor liquid.

For some applications of the method, it may be advantageous to use layers of powder of different compositions. In an embodiment, at least two of the powder layers provided during the additive manufacturing of the component have different compositions. In an embodiment, the component is manufactured using at least two layers of powder with different compositions.

The inventor has found that the thickness of the layer(s) provided may be particularly relevant to, among others, the build resolution of certain components. In this respect, the inventor has found that for some applications of the method, where the component is manufactured from a single layer of powder or not from a large number of layers, the use of particularly thick layers may be preferable. In different embodiments, the thickness of the layer of powder is less than 49 m, less than 19 m, less than 9 m, less than 4.9 m and even less than 0.9 m. For certain applications, the use of layers with a minimum thickness may be advantageous. In different embodiments, the thickness of the layers is at least 16 mm, at least 110 mm, at least 220 mm, at least 220 mm, at least 510 mm and even at least 1.1 m. All the embodiments disclosed above can be combined among them and with any other embodiment disclosed in this document in any combination provided that they are not mutually exclusive, for example, in an embodiment, when the component is manufactured from a single layer or less than 10 layers of powder, the thickness of the layer or layers of powder provided is between 16 mm and 49 m. On the other hand, for certain applications of the method, where the component is manufactured from a large number of layers, the use of thinner layers may be preferable. In different embodiments, the thickness of the layer of powder is less than 49 cm, less than 24 cm, less than 9 cm, less than 4 cm and even less than 0.8 cm. For certain applications, the use of layers with a minimum thickness may be advantageous. In different embodiments, the thickness of the layers is at least 0.4 microns, at least 11 microns, at least 61 microns, at least 120 microns, and even at least 600 microns. All the embodiments disclosed above can be combined among them and with any other embodiment disclosed in this document in any combination provided that they are not mutually exclusive, for example, in an embodiment, when the component is manufactured from more than 10 layers of powder, the thickness of the layers of powder provided is between 0.4 microns and 49 cm. The feature “large number of layers” is defined throughout this paragraph in the form of different alternatives that are explained in detail below. In an embodiment, a large number of layers is 10 or more layers. In an alternative embodiment, a large number of layers is 11 or more layers. In another alternative embodiment, a large number of layers is 31 or more layers. In another alternative embodiment, a large number of layers is 52 or more layers. In another alternative embodiment, a large number of layers is 102 or more layers. For some applications, it may be particularly advantageous to change the thickness of the layers of powder provided during the application of the printing method, which may result in an increase in the spatial resolution of certain printed components. In an embodiment, the thickness of the layers of powder provided is at first reduced, and later increased. In another embodiment, the thickness of the layers of powder provided is at first increased, and later reduced. For some applications, the thickness of the layer of powder does not need to be constant. In an embodiment, the thickness of at least one of the layers of powder provided is different at different points of that layer. For some applications, it may be particularly advantageous to use layers of powder of different thicknesses. In an embodiment, the powder bed comprises layers of powder of different thicknesses.

Some examples of technologies that may be used to obtain the powders include, but are not limited to, atomization (e.g., centrifugal atomization, water atomization, gas atomization, . . . ), droplet atomization (e.g., ultrasonic, piezoelectric, plasma gun, . . . ), oxide reduction, mechanical action, comminution, grinding, crushing, attrition, milling (e.g., ball milling, . . . ), energy breaking and/or combinations thereof. The inventor has found that for some applications, it may be particularly relevant to provide a powder bed with a right size of the voids between the particles in the powder bed. In different embodiments the right size of the voids is a size of 980 microns or less, of 480 microns or less, of 180 microns or less, of 80 microns or less, of 40 microns or less, of 19 microns or less, of 9 microns or less, and even of 0.9 microns or less. For some applications, excessive voids may be detrimental. In different embodiments, the right size of the voids is a size of 980 microns or less, of 480 microns or less, of 180 microns or less, of 80 microns or less, of 40 microns or less, of 19 microns or less, of 9 microns or less, and even of 0.9 microns or less. In an embodiment, the size refers to the mean size. The inventor has found that for some applications, it may be particularly relevant to provide a powder bed with a right size of the particles in the powder bed. In different embodiments, the right size of the particles is a size of 60 nanometres or more, of 540 nanometres or more, of 1.4 microns or more, of 6 microns or more, of 12 microns or more, of 22 microns or more, of 52 microns or more, and even of 102 microns or more. For some applications, excessively large particles should be avoided. In different embodiments, the right size of the particles is a size of 980 microns or less, of 480 microns or less, of 180 microns or less, of 80 microns or less, of 40 microns or less, of 19 microns or less, of 9 microns or less, and even of 0.9 microns or less. All the embodiments disclosed above can be combined among them and with any other embodiment disclosed in this document in any combination provided that they are not mutually exclusive, for example, in an embodiment, the right size of the voids between the particles in the powder bed is a size between 60 nanometres and 980 microns; or for example, in another embodiment, the right size of the particles in the powder bed is a size between 60 nanometres and 980 microns. Unless otherwise indicated, the feature “size” of the particles is defined throughout this document in the form of different alternatives that are explained in detail below. In an embodiment, the size of the particles refers to D50. In an alternative embodiment, the size of the particles refers to D10. In another alternative embodiment, the size of the particles refers to D90. In another alternative embodiment, the size of the particles refers to the smallest mesh that lets only 10% of the powder retained. In another alternative embodiment, the size of the particles refers to the smallest mesh that allows 50% of the powder pass through. In another alternative embodiment, the size of the particles refers to the equivalent diameter of the mean void between particles volume of all voids between particles. In another alternative embodiment, the size of the particles refers to the mean size. In another alternative embodiment, the size of the particles refers to the size of the smallest powder. In another alternative embodiment, the size of the particles refers to the size of the largest powder. Throughout this document, unless otherwise stated, the mean refers to the arithmetic mean. Unless otherwise indicated, the feature “D50” is defined throughout this document in the form of different alternatives that are explained in detail below. In an embodiment, D50 refers to the particle size at which 50% of the sample's volume is comprised of smaller particles in the cumulative distribution of particle size. In an alternative embodiment, D50 refers to the particle size at which 50% of the sample's mass is comprised of smaller particles in the cumulative distribution of particle size. Unless otherwise indicated, the feature “D10” is defined throughout this document in the form of different alternatives that are explained in detail below. In an embodiment, D10 refers to the particle size at which 10% of the sample's volume is comprised of smaller particles in the cumulative distribution of particle size. In an alternative embodiment, D10 refers to the particle size at which 10% of the sample's mass is comprised of smaller particles in the cumulative distribution of particle size. Unless otherwise indicated, the feature “D90” is defined throughout this document in the form of different alternatives that are explained in detail below. In an embodiment, D90 refers to the particle size at which 90% of the sample's volume is comprised of smaller particles in the cumulative distribution of particle size. In an alternative embodiment, D90 refers to the particle size at which 90% of the sample's mass is comprised of smaller particles in the cumulative distribution of particle size. In an embodiment, particle size is measured by laser diffraction according to ISO 13320-2009. All the embodiments disclosed above can be combined with any other embodiment disclosed in this document that relates to the size of a particulate material in any combination, provided that they are not mutually exclusive.

The inventor has found that for some applications, it may be particularly relevant to correctly choose the wavelength of the radiation as a function of the particle size (as defined in this document) in the powder bed. In different embodiments, the size of the particles in the powder bed is 4.8 times or less, 0.9 times or less, 0.25 times or less, 0.009 times or less, 0.004 times or less, 0.0009 times or less, 0.9 e⁻⁴ times or less, and even 0.98 e⁻⁵ times or less the length of the radiation wavelength. In different embodiments, the size of the particles in the powder bed is 0.98 e⁻⁶ times or more, 1.2 e⁻⁵ times or more, 1.2 e⁻⁴ times or more, 0.0012 times or more, 0.022 times or more, 0.28 times or more, 0.8 times or more, and even 1.2 times or more the length of the wavelength. In some embodiments, it may be difficult to control the size of the voids, and it may be preferable to control the ratio between the minimum and maximum size of the particles (the maximum size being determined as a function of the wavelength of “the proper radiation” as described above). All the embodiments disclosed above can be combined among them and with any other embodiment disclosed in this document in any combination provided that they are not mutually exclusive, for example, in an embodiment, the size of the particles in the powder bed is between 0.98 e⁻⁶ and 4.8 times the length of the wavelength. In different embodiments, the minimum size of the particles in the powder bed should be 0.79 times or more, 0.68 times or more, 0.49 times or more, and even 0.18 times or more the maximum size of the particles.

The inventor has found that for some applications, it may be particularly relevant to correctly choose the wavelength of the radiation to be used as a function of the size of the voids. In different embodiments, the size of the voids between the particles is 0.98 times or less, 0.88 times or less, 0.68 times or less, 0.58 times or less, 0.48 times or less, 0.28 times or less, 0.08 times or less, and even 0.008 times or less the length of the wavelength.

The inventor has found that for some applications, it may be particularly relevant to ensure that at least part of the particles in the powder bed are chosen with a right value of the parameter PTC, wherein the parameter PTC is calculated using the formula: PTC=specific heat*density*thermal conductivity, where specific heat is given in J/(g*K), density is given in g/cm³, thermal conductivity is given in W/(m*K), and specific heat and thermal conductivity are at room temperature (23° C.). In different embodiments, at least part of the particles are chosen with a value of the parameter PTC of 11 or more, of 21 or more, of 42 or more, of 62 or more, of 110 or more of 160 or more, and even of 210 or more. All the embodiments disclosed above can be combined among them and with any other embodiment disclosed in this document in any combination provided that they are not mutually exclusive, for example, in an embodiment, at least part of the particles in the powder bed are chosen with a value of parameter PTC of 11 or more, being the parameter PTC calculated using the formula: PTC=specific heat*density*thermal conductivity, wherein specific heat is given in J/(g*K), density is given in g/cm3, thermal conductivity is given in W/(m*K), and specific heat and thermal conductivity are at room temperature (23° C.). In an alternative embodiment, the PTC values given above refers to the mean of all the particles present in the material. In another alternative embodiment, the PTC values given above refer to the mean PTC value considering all metallic particles present in the powder bed. In another alternative embodiment, the PTC values given above refer to the mean PTC value considering all ceramic particles present in the powder bed. In different embodiment, at least part of the particles refers to 1.6% by volume or more, 5.6% by volume or more, 21% by volume or more, 41% by volume or more and even to 61% by volume or more of the particles. In an alternative embodiment, these percentages refer to weight percentages.

In an embodiment, the method comprises the use of at least one radiation generator. The inventor has found that for some applications, the radiation employed may be particularly relevant to achieving the desired selective consolidation of the powder bed. In an embodiment, the radiation to which the powder bed is exposed in step 2 is a proper radiation (as described in this document). The inventor has found that the use of this precise radiation allows an unexpectedly high speed of consolidation. In an embodiment, the proper radiation refers to the adequate radiation to produce the selective consolidation of at least part of the powder contained in the powder bed. Unless otherwise indicated, the feature “proper radiation” is defined throughout this document in the form of different alternatives that are explained in detail below. In an embodiment, the proper radiation comprises radiation in the microwave range. In another embodiment, the proper radiation is radiation in the microwave range. In different embodiments, the proper radiation refers to a radiation with a frequency of 2.45 GHz +/−250 MHz, of 5.8 GHz +/−1050 MHz, of 915 MHz +/−250 MHz and even of 2.45 MHz +/−250 MHz. In an alternative embodiment, the proper radiation comprises radiation in the Tera Hertz (THz) range. In another embodiment, the proper radiation is radiation in the Tera Hertz (THz) range. In different embodiments, the proper radiation refers to a radiation with a frequency of 120 THz or less, of 89 THz or less, of 69 THz or less, of 49 THz or less, of 20 THz or less, of 19 THz or less, of 9 THz or less, of 2.1 THz or less, of 0.9 THz or less, of 0.8 THz or less and even of 0.03 THz or less. For some applications, the frequency of the proper radiation cannot be too low. In different embodiments the proper radiation refers to a radiation with a frequency of 0.0002 THz or more, of 0.0012 THz or more, of 0.006 THz or more, of 0.012 THz or more, of 0.08 THz or more, 0.2 THz or more, of 1.1 THz or more, of 11 THz or more, of 21 THz or more, of 56 THz or more, and even of 102 THz or more. All the embodiments disclosed above can be combined among them and with any other embodiment disclosed in this document in any combination provided that they are not mutually exclusive, for example, in an embodiment, the proper radiation is a radiation with a frequency between 0.0002 and 120 THz or less. In another alternative embodiment, the proper radiation comprises radiation with a certain wavelength. In different embodiments, the proper radiation refers to radiation with a wavelength of 0.00008 cm or more, 0.0006 cm or more, of 0.0012 cm or more, of 0.06 cm or more, of 0.2 cm or more, of 1.15 cm or more, of 6 cm or more, and even of 11 cm or more. For certain applications, the wavelength should be limited. In different embodiments, the proper radiation refers to radiation with a wavelength of 59 cm or less, 19 cm or less, of 14 cm or less, of 9 cm or less, of 4 cm or less, of 0.9 cm or less, of 0.04 cm or less and even of 0.09 cm or less. All the embodiments disclosed above can be combined among them and with any other embodiment disclosed in this document in any combination provided that they are not mutually exclusive, for example, in an embodiment, the proper radiation is a radiation with a wavelength between 0.0006 and 59 cm; or for example, in another embodiment, the proper radiation is a radiation with a wavelength between 0.0006 and 19 cm; or for example in another embodiment, the proper radiation is a radiation with a wavelength between 0.2 and 19 cm. Different types of radiation may be advantageously employed. In another alternative embodiment, the proper radiation is non-ionizing radiation. This greatly simplifies the construction of the setups, as the potential harmfulness of the radiation is far less. In another alternative embodiment, the proper radiation is coherent radiation. In another alternative embodiment, the proper radiation is coherent radiation that can remain coherent even after the penetration into the powder bed. In another alternative embodiment, the proper radiation is a free propagating radiation, composed of one or more discrete wavelengths. In another alternative embodiment, the proper radiation is defined in terms of the mean photon quantum energy. In different embodiments, the proper radiation is a radiation with a mean photon quantum energy of 0.6 e⁻⁵ eV or more, of 1.1 e⁻⁵ eV or more, of 1.2 e⁻⁴ eV or more, of 1.2 e⁻³ eV or more, of 3.1 e⁻³ eV or more, of 4.6 e⁻³ eV or more, and even of 5.1 e⁻³ eV or more. For some applications, too high quantum energy may be detrimental. In different embodiments, the proper radiation is a radiation with a mean photon quantum energy of 5.9 e⁻³ eV or less, of 4.9 e⁻³ eV or less, of 3.9 e⁻³ eV or less, of 1.9 e⁻³ eV or less, of 1.9 e⁻⁴ eV or less, and even of 1.9 e⁻⁵ eV or less. All the embodiments disclosed above can be combined among them and with any other embodiment disclosed in this document in any combination provided that they are not mutually exclusive, for example, in an embodiment, the proper radiation is a radiation with a mean photon quantum energy between 0.6 e⁻⁵ and 5.9 e⁻³ eV.

The inventor has found that for some applications, it may be particularly relevant to correctly choose the maximum temperature at which the powder bed is exposed in step 2. In different embodiments, the maximum temperature at which the powder bed is exposed in step 2 is less than 0.6*Tm, less than 0.5*Tm, less than 0.45*Tm, less than 0.4*Tm, less than 0.35*Tm and even less than 0.3*Tm, which is below the sintering and melting temperature of the powder, to which Tm refers to. Throughout this document, unless otherwise stated, the melting temperature (Tm) refers to the temperature at which the first liquid forms under equilibrium conditions. Throughout this document, unless otherwise indicated, when referring to metallic powders, the feature “Tm” is defined in the form of different alternatives that are explained in detail below. In an embodiment, Tm is the melting temperature in degrees Kelvin of the metallic powder in the powder bed with the highest melting point. In an alternative embodiment, Tm is the melting temperature in degrees Kelvin of the metallic powder in the powder bed with the lowest melting point. In another alternative embodiment, Tm is the mean melting temperature in degrees Kelvin of all the metallic powders in the powder bed. In another alternative embodiment, Tm is the weighted mean melting temperature in degrees Kelvin of all the metallic powders in the powder bed (mass-weighted arithmetic mean, where the weights are the weight fractions). In another alternative embodiment, Tm is the melting temperature of the metallic powder in the powder bed which is the main component (as defined in this document). In another alternative embodiment, Tm is the melting temperature of the metallic powder in at least one layer of powder which is the main component (as defined in this document). In another alternative embodiment, the above melting temperatures are in degrees Celsius. All the embodiments disclosed above can be combined among them and with any other embodiment disclosed in this document in any combination provided that they are not mutually exclusive, for example, in an embodiment, the maximum temperature at which the powder bed is exposed in step 2 is less than 0.5*Tm, which is below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the metallic powder in the powder bed with the highest melting point, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the metallic powder in the powder bed with the lowest melting point, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the metallic powder in the powder bed which is the main component, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the metallic powder in at least one layer of powder which is the main component, said maximum temperature being below the sintering and melting temperature of the powder, to which Tm refers to. Throughout this document, unless otherwise indicated, when referring to ceramic powders, the feature “Tm” is defined in the form of different alternatives that are explained in detail below. In an embodiment, Tm is the melting temperature in degrees Kelvin of the ceramic powder in the powder bed with the highest melting point. In an alternative embodiment, Tm is the melting temperature in degrees Kelvin of the ceramic powder in the powder bed with the lowest melting point. In another alternative embodiment, Tm is the mean melting temperature in degrees Kelvin of all the ceramic powders in the powder bed. In another alternative embodiment, Tm is the weighted mean melting temperature in degrees Kelvin of all the ceramic powders in the powder bed (mass-weighted arithmetic mean, where the weights are the weight fractions). In another alternative embodiment, Tm is the melting temperature in degrees Kelvin of the ceramic powder in the powder bed which is the main component (as defined in this document). In another alternative embodiment, Tm is the melting temperature of the ceramic powder in at least one layer of powder which is the main component (as defined in this document). In another alternative embodiment, the above melting temperatures are in degrees Celsius. All the embodiments disclosed above can be combined among them and with any other embodiment disclosed in this document in any combination provided that they are not mutually exclusive, for example, in an embodiment, the maximum temperature at which the powder bed is exposed in step 2 is less than 0.5*Tm, where Tm is the melting temperature in degrees Kelvin of the ceramic powder in the powder bed with the highest melting point, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the ceramic powder in the powder bed with the lowest melting point, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature in degrees Kelvin of the ceramic powder in the powder bed which is the main component, said maximum temperature being below the sintering and melting temperature of the powder, to which Tm refers to; or for example in another embodiment, the maximum temperature at which the powder bed is exposed in step 2 is less than 0.5*Tm, where Tm is the melting temperature of the ceramic powder in at least one layer of powder which is the main component, said maximum temperature being below the sintering and melting temperature of the powder, to which Tm refers to. Unless otherwise indicated, the feature “main component” is defined throughout this document in the form of different alternatives that are explained in detail below. In an embodiment, the main component is the component with the highest weight percentage in the powder bed, wherein if there are two or more components with the same weight percentage that are the components with the highest weight percentage in the powder bed, then the main component is the component with the highest density among them, and if the two or more components with the highest weight percentage in the powder bed have the same density, then the main component is the component with the highest melting temperature among them. In an alternative embodiment, the main component is the component with the highest volume percentage in the powder bed, wherein if there are two or more components with the same volume percentage that are the components with the highest volume percentage in the powder bed, then the main component is the component with the highest density among them, and if the two or more components with the highest volume percentage in the powder bed have the same density, then the main component is the component with the highest melting temperature among them. In an embodiment, the powder bed, or at least one of the layers of powder in the powder bed comprises a main component. For some applications of the method, when the powder bed comprises a polymer, it may also be particularly relevant to correctly choose the maximum temperature at which the powder bed is exposed in step 2 depending on the melting temperature of the polymer. In different embodiments, the maximum temperature at which the powder bed is exposed in step 2 is greater than 0.3*Tmp, greater than 0.45*Tmp, greater than 0.5*Tmp, greater than 0.55*Tmp, greater than 0.6*Tmp, greater than 0.7*Tmp, and even strictly above Tmp. Unless otherwise indicated, the melting temperature (Tmp) of any polymer is measured according to ISO 11357-1/-3:2016. In an embodiment, the melting temperature of the polymers is measured applying a heating rate of 20° C./min. Throughout this document, unless otherwise indicated, the feature “Tmp” is defined in the form of different alternatives that are explained in detail below. In an embodiment, Tmp is the melting temperature in degrees Celsius of the polymer with the lowest melting point in the powder bed. In an alternative embodiment, Tmp is the melting temperature in degrees Celsius of the polymer with the highest melting point in the powder bed. In another alternative embodiment, Tmp is the mean melting temperature in degrees Celsius of all the polymers in the powder bed. In another alternative embodiment, Tmp is the weighted mean melting temperature in degrees Celsius of all the polymers in the powder bed (mass-weighted arithmetic mean, where the weights are the weight fractions). In another alternative embodiment, Tmp is the melting temperature of the polymer in the powder bed which is the main polymeric component (as defined in this document). In another alternative embodiment, Tmp is the melting temperature of the polymer in at least one layer which is the main polymeric component (as defined in this document). In another alternative embodiment, the above melting temperatures are in degrees Kelvin. All the embodiments disclosed above can be combined among them and with any other embodiment disclosed in this document in any combination provided that they are not mutually exclusive, for example, in an embodiment, the maximum temperature at which the powder bed is exposed in step 2 is greater than 0.5*Tmp; or for example, in another embodiment, the maximum temperature at which the powder bed is exposed in step 2 is greater than 0.5*Tmp, where Tmp is the melting temperature in degrees Celsius of the polymer with the lowest melting point in the powder bed; or for example in another embodiment, the maximum temperature at which the powder bed is exposed in step 2 is greater than 0.5*Tmp, where Tmp is the melting temperature in degrees Celsius of the polymer with the highest melting point in the powder bed; or for example in another embodiment, the maximum temperature at which the powder bed is exposed in step 2 is greater than 0.5*Tmp, where Tmp is the melting temperature in degrees Celsius of the polymer in the powder bed which is the main polymeric component. For some applications of the method, when the powder bed comprises a polymer, it may also be particularly relevant to correctly choose the maximum temperature at which the powder bed is exposed in step 2 depending on the Vicat softening temperature of the polymer. In different embodiments, the maximum temperature at which the powder bed is exposed in step 2 is greater than 0.3*Ts, greater than 0.45*Ts, greater than 0.5*Ts, greater than 0.55*Ts, greater than 0.6*Ts, greater than 0.7*Ts, and even strictly above Ts. In an alternative embodiment, the values of Ts are in degrees Kelvin. In an embodiment, the Vicat softening temperature (Ts) is determined with a heating rate of 50° C./h. In an embodiment, the Vicat softening temperature is determined with a load of 50N. In an embodiment, the Vicat softening temperature (Ts) is determined according to ISO 306 standard. In another embodiment, the Vicat softening temperature (Ts) is determined according to ASTM D1525 standard. In another embodiment, the Vicat softening temperature (Ts) is determined according to the B50 method. In another embodiment, the Vicat softening temperature (Ts) is determined according to the A120 method and 18° C. are subtracted from the value measured. In another embodiment, the Vicat softening temperature (Ts) is determined according to ISO 10350-1 standard using method B50. Throughout this document, unless otherwise indicated, the feature “Ts” is defined in the form of different alternatives that are explained in detail below. In an embodiment, Ts is the Vicat softening temperature in degrees Celsius of the polymer with the lowest Vicat softening temperature in the powder bed. In another alternative embodiment, Ts is the Vicat softening temperature in degrees Celsius of the polymer with the highest Vicat softening temperature in the powder bed. In another alternative embodiment, Ts is the mean Vicat softening temperature in degrees Celsius of all the polymers in the powder bed. In another alternative embodiment, Ts is the weighted mean Vicat softening temperature in degrees Celsius of all the polymers in the powder bed (mass-weighted arithmetic mean, where the weights are the weight fractions). In another alternative embodiment, Ts is the Vicat softening temperature of the polymer in the powder bed which is the main polymeric component (as defined in this document). In another alternative embodiment, Ts is the Vicat softening temperature of the polymer in at least one layer which is the main polymeric component (as defined in this document). In another alternative embodiment, the above Vicat softening temperatures are in degrees Kelvin. All the embodiments disclosed above can be combined among them and with any other embodiment disclosed in this document in any combination provided that they are not mutually exclusive, for example, in an embodiment, the maximum temperature at which the powder bed is exposed in step 2 is greater than 0.5*Ts; or for example, in another embodiment, the maximum temperature at which the powder bed is exposed in step 2 is greater than 0.5*Ts, where Ts is the Vicat softening temperature in degrees Celsius of the polymer with the lowest Vicat softening temperature in the powder bed; or for example, in another embodiment, the maximum temperature at which the powder bed is exposed in step 2 is greater than 0.5*Ts, where Ts is the Vicat softening temperature in degrees Celsius of the polymer with the highest Vicat softening temperature in the powder bed; or for example, in another embodiment, the maximum temperature at which the powder bed is exposed in step 2 is greater than 0.5*Ts, where Tmp is the Vicat softening temperature in degrees Celsius of the polymer in the powder bed which is the main polymeric component. For some applications of the method, when the powder bed comprises a polymer, it may also be particularly relevant to correctly choose the maximum temperature at which the powder bed is exposed in step 2 depending on the heat deflection temperature (HDT) measured with a load of 0.455 MPa (hereinafter referred to as HDT at 0.455 MPa) of the polymer. In different embodiments, the maximum temperature at which the powder bed is exposed in step 2 is greater than 0.3* HDT at 0.455 MPa, greater than 0.45* HDT at 0.455 MPa, greater than 0.5*Ts HDT at 0.455 MPa, greater than 0.55* HDT at 0.455 MPa, greater than 0.6* HDT at 0.455 MPa, greater than 0.7* HDT at 0.455 MPa, and even strictly above HDT at 0.455 MPa. In an embodiment, the HDT at 0.455 MPa is determined with a heating rate of 50° C./h. In an embodiment, the values of HDT at 0.455 MPa at 0.455 MPa are determined according to ASTM D648-07 standard test method. In an alternative embodiment, the HDT at 0.455 MPa is determined according to ISO 75-1:2013 standard. In another alternative embodiment, the HDT at 0.455 MPa reported for the closest material in the UL IDES Prospector Plastic Database at 29/01/2018 is used. Throughout this document, unless otherwise indicated, the feature “HDT at 0.455 MPa” is defined in the form of different alternatives that are explained in detail below. In an embodiment, the HDT at 0.455 MPa is the heat deflection temperature measured with a load of 0.455 MPa in degrees Celsius of the polymer with the lowest HDT at 0.455 MPa in the powder bed. In another alternative embodiment, the HDT at 0.455 MPa is the heat deflection temperature measured with a load of 0.455 MPa in degrees Celsius of the polymer with the HDT at 0.455 MPa in the powder bed. In another alternative embodiment, the HDT at 0.455 MPa is the mean heat deflection temperature measured with a load of 0.455 MPa in degrees Celsius of all the polymers in the powder bed. In another alternative embodiment, the HDT at 0.455 MPa is the weighted mean heat deflection temperature measured with a load of 0.455 MPa in degrees Celsius of all the polymers in the powder bed (mass-weighted arithmetic mean, where the weights are the weight fractions). In another alternative embodiment, the HDT at 0.455 MPa is the heat deflection temperature measured with a load of 0.455 MPa of the polymer in the powder bed which is the main polymeric component (as defined in this document). In another alternative embodiment, the HDT at 0.455 MPa is the heat deflection temperature measured with a load of 0.455 MPa of the polymer in at least one layer which is the main polymeric component (as defined in this document). In another alternative embodiment, the heat deflection temperature measured with a load of 0.455 MPa is in degrees Kelvin. All the embodiments disclosed above can be combined among them and with any other embodiment disclosed in this document in any combination provided that they are not mutually exclusive, for example, in an embodiment, the maximum temperature at which the powder bed is exposed in step 2 is greater than 0.5* HDT at 0.455 MPa; or for example, in another embodiment, the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer with the lowest HDT at 0.455 MPa in the powder bed; or for example in another embodiment, the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer with the highest HDT at 0.455 MPa in the powder bed; or for example in another embodiment, the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer in the powder bed which is the main polymeric component. For some applications of the method, when the powder bed comprises a polymer, it may also be particularly relevant to correctly choose the maximum temperature at which the powder bed is exposed in step 2 depending on the heat deflection temperature (HDT) measured with a load of 1.82 MPa (hereinafter referred to as HDT at 1.82 MPa) of the polymer. In different embodiments, the maximum temperature at which the powder bed is exposed in step 2 is greater than 0.3* HDT at 1.82 MPa, greater than 0.45* HDT at 1.82 MPa, greater than 0.5*Ts HDT at 1.82 MPa, greater than 0.55* HDT at 1.82 MPa, greater than 0.6* HDT at 1.82 MPa, greater than 0.7* HDT at 1.82 MPa, and even strictly above HDT at 1.82 MPa. In an embodiment, the HDT at 1.82 MPa is determined with a heating rate of 50° C./h. In an embodiment, the values of HDT at 1.82 MPa at 1.82 MPa are determined according to ASTM D648-07 standard test method. In an alternative embodiment, the HDT at 1.82 MPa is determined according to ISO 75-1:2013 standard. In another alternative embodiment, the HDT at 1.82 MPa reported for the closest material in the UL IDES Prospector Plastic Database at 29/01/2018 is used. Throughout this document, unless otherwise indicated, the feature “HDT at 1.82 MPa” is defined in the form of different alternatives that are explained in detail below. In an embodiment, the HDT at 1.82 MPa is the heat deflection temperature measured with a load of 1.82 MPa in degrees Celsius of the polymer with the lowest HDT at 1.82 MPa in the powder bed. In another alternative embodiment, the HDT at 1.82 MPa is the heat deflection temperature measured with a load of 1.82 MPa in degrees Celsius of the polymer with the HDT at 1.82 MPa in the powder bed. In another alternative embodiment, the HDT at 1.82 MPa is the mean heat deflection temperature measured with a load of 1.82 MPa in degrees Celsius of all the polymers in the powder bed. In another alternative embodiment, the HDT at 1.82 MPa is the weighted mean heat deflection temperature measured with a load of 1.82 MPa in degrees Celsius of all the polymers in the powder bed (mass-weighted arithmetic mean, where the weights are the weight fractions). In another alternative embodiment, the HDT at 1.82 MPa is the heat deflection temperature measured with a load of 1.82 MPa of the polymer in the powder bed which is the main polymeric component (as defined in this document). In another alternative embodiment, the HDT at 1.82 MPa is the heat deflection temperature measured with a load of 1.82 MPa of the polymer in at least one layer which is the main polymeric component (as defined in this document). In another alternative embodiment, the heat deflection temperature measured with a load of 1.82 MPa are in degrees Kelvin. All the embodiments disclosed above can be combined among them and with any other embodiment disclosed in this document in any combination provided that they are not mutually exclusive, for example, in an embodiment, the maximum temperature at which the powder bed is exposed in step 2 is greater than 0.5* HDT at 1.82 MPa; or for example, in another embodiment, the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer with the lowest HDT at 1.82 MPa in the powder bed; or for example, in another embodiment, the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer with the highest HDT at 1.82 MPa in the powder bed; or for example, in another embodiment, the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer in the powder bed which is the main polymeric component. Unless otherwise indicated, the feature “main polymeric component” is defined throughout this document in the form of different alternatives that are explained in detail below. In an embodiment, the main polymeric component is the polymer with the highest weight percentage in the powder bed, wherein if there are two or more polymers with the same weight percentage that are the polymers with the highest weight percentage in the powder bed, then the main polymeric component is the polymer with the lowest melting temperature. In an alternative embodiment, the main polymeric component is the polymer with the highest weight percentage in the powder bed, wherein if there are two or more polymers with the same weight percentage that are the polymers with the highest weight percentage in the powder bed, then the main polymeric component is the polymer with the lowest Vicat softening temperature. In another alternative embodiment, the main polymeric component is the polymer with the highest volume percentage in the powder bed, wherein if there are two or more polymers with the same volume percentage that are the polymers with the highest volume percentage in the powder bed, then the main polymeric component is the polymer with the lowest melting temperature. In another alternative embodiment, the main polymeric component is the polymer with the highest volume percentage in the powder bed, wherein if there are two or more polymers with the same volume percentage that are the polymers with the highest volume percentage in the powder bed, then the main polymeric component is the polymer with the lowest Vicat softening temperature. In an embodiment, the powder bed and/or at least one of the layers in the powder bed comprises a main polymeric component. All the embodiments disclosed above can be combined among them and with any other embodiment disclosed in this document in any combination provided that they are not mutually exclusive, for example, in an embodiment, the maximum temperature at which the powder bed is exposed in step 2 is less than 0.5*Tm and greater than 0.5*Tmp, where Tm is the melting temperature in degrees Kelvin of the metallic powder in the powder bed with the highest melting point and Tmp is the melting temperature in degrees Celsius of the polymer high the lowest melting point in the powder bed; or for example in another embodiment, the maximum temperature at which the powder bed is exposed in step 2 is less than 0.5*Tm and greater than 0.5*Ts, where Tm is the melting temperature in degrees Celsius of the metallic powder in the powder bed with the highest melting point and Ts is the Vicat softening temperature in degrees Celsius of the polymer high the lowest melting point in the powder bed; or for example in another embodiment, the maximum temperature at which the powder bed is exposed in step 2 is less than 0.5*Tm and greater than 0.5* HDT at 0.455 MPa, where Tm is the melting temperature in degrees Celsius of the metallic powder in the powder bed with the highest melting point and 0.5* HDT at 0.455 MPa HDT is the heat deflection temperature measured with a load of 0.455 MPa in degrees Celsius of the polymer with the lowest HDT at 1.82 MPa in the powder bed; or for example in another embodiment, the maximum temperature at which the powder bed is exposed in step 2 is less than 0.5*Tm and greater than 0.5* HDT at 1.82 MPa, where Tm is the melting temperature in degrees Celsius of the metallic powder in the powder bed with the highest melting point and 0.5* HDT at 1.82 MPa HDT is the heat deflection temperature measured with a load of 1.82 MPa in degrees Celsius of the polymer with the lowest HDT at 1.82 MPa in the powder bed.

For certain applications, the radiation field strength to which the different points of the powder bed are exposed may be of particular importance. In this regard, the inventor has found that for some applications, it may be particularly advantageous to ensure that there are points in the powder bed which are exposed to different field strengths in step 2. In an embodiment, there are points in the powder bed which are exposed to different radiation field strengths in step 2. In an embodiment, there are points in the powder bed which are exposed to a higher radiation field strength than other points in the powder bed at least at one point in time in step 2. For some applications, it may be particularly advantageous to ensure that there are different subsets of points in the powder bed which are exposed to different field strengths at different points in time. In different embodiments, a subset of points refers to 2 points or more, 11 points or more, 51 points or more, 111 points or more, 1100 points or more, and even 10200 points or more. In different embodiments, a subset of points refers to 990000 points or less, 98000 points or less, 79000 points or less and even 900 points or less. All the embodiments disclosed above can be combined among them and with any other embodiment disclosed in this document in any combination provided that they are not mutually exclusive, for example, in an embodiment, a subset of points consists of a number of points between 2 and 79000; or for example in another embodiment between 11 and 900 points. The points of each subset of points do not necessarily need to be adjacent to each other. In an embodiment, the points of each subset of points are adjacent to each other. In another embodiment, the points of each subset of points are not in every case adjacent to each other. For example, the points within a given subset of points may be contiguous or they may be located in different parts of the powder bed. In an embodiment, all of the points in a given subset of points are contiguous. In another embodiment, at least some of the points in a given subset of points are not contiguous. In an embodiment, at a first point in time in step 2, there is a first subset of points in the powder bed which is exposed to a substantially higher radiation field strength than a second subset of points in the powder bed; and wherein at a second point in time in step 2, the second subset of points in the powder bed is exposed to a substantially higher radiation field strength than the first subset of points in the powder bed. In another embodiment, at a first point in time in step 2, there are a first and a second subset of points in the powder bed which are exposed to a substantially higher radiation field strength than a third subset of points in the powder bed; and wherein at a second point in time in step 2, the second and third subset of points in the powder bed are exposed to a substantially higher radiation field strength than the first subset of points in the powder bed. In an embodiment, the second point in time is later than the first point in time. In another embodiment, there is a first subset of points in the powder bed which is exposed to a substantially higher radiation field strength than a second subset of points in the powder bed; and wherein at a second point in time in step 2, there is no significant difference between the radiation field strength to which the first and second subset of points are exposed. In another embodiment, at a first point in time in step 2, there is a first subset of points in the powder bed which is exposed to a substantially higher radiation field strength than a second subset of points in the powder bed; wherein at a second point in time in step 2, there is no significant difference between the radiation field strength to which the first and second subset of points are exposed; and wherein at a third point in time in step 2, the second subset of points in the powder bed is exposed to a substantially higher radiation field strength than the first subset of points in the powder bed. In an embodiment, the third point in time is later than the second point in time. In an embodiment, the second point in time is later than the first point in time and the third point in time is later than the second point in time. In another embodiment, at a first point in time in step 2, there is a first subset of points in the powder bed which is exposed to a substantially higher radiation field strength than a second subset of points in the powder bed; wherein at a second point in time in step 2, there is no significant difference in the radiation field strength to which the first and second subset of points are exposed; wherein at a third point in time in step 2, the second subset of points in the powder bed is exposed to a substantially higher radiation field strength than the first subset of points in the powder bed; and wherein at a fourth point in time in step 2, the first subset of points in the powder bed is exposed to a substantially higher radiation field strength than the second subset of points in the powder bed. In an embodiment, the fourth point in time is later than the third point in time. In an embodiment, the second point in time is later than the first point in time, the third point in time is later than the second point in time and the fourth point in time is later than the third point in time. In certain particular embodiments, the different subsets of points described above may be at least partially coincident. Unless otherwise indicated, the feature “points in the powder bed” is defined throughout this document in the form of different alternatives that are explained in detail below. In an embodiment, each point is a powder particle. In another embodiment, each point is a voxel. Unless otherwise indicated, the feature “voxel” is defined throughout this document in the form of different alternatives that are explained in detail below. In an embodiment, a voxel refers to a three-dimensional pixel. In an alternative embodiment, a voxel refers to a cubic volume with an assigned value or values in a regular three-dimensional Cartesian grid. In another alternative embodiment, a voxel refers to a polyhedron with cubic geometry (hereinafter referred to as “cubic voxel”) and a defined edge length. In different embodiments, the edge length of the cubic voxel is selected from 1 mm, 0.9 mm, 0.09 mm, 0.04 mm, 0.01 mm, 0.009 mm and even 0.001 mm. All the embodiments disclosed above can be combined among them and with any other embodiment disclosed in this document in any combination provided that they are not mutually exclusive, for example, in an embodiment, the voxel is a polyhedron with cubic geometry and an edge length of 0.001 mm. In another alternative embodiment, a voxel refers to a polyhedron with a rectangular cubic geometry (hereinafter referred to as “rectangular cuboid voxel”). In an embodiment, there is a certain relationship between the volume of the rectangular cuboid voxels (Vrc) and the volume of the powder bed according to the following formula: Vrc=V/n³, where Vrc is the rectangular cuboid voxel volume in m³, V is the powder bed volume in m³ and n³ is the number of rectangular cuboid voxels that are contained in the powder bed. In different embodiments, n is selected from 12, 120, 580, 1060, 4400, 5800, 9100, 10600, 19100, 41000, 91000 and even 980000. For some applications, it may be advantageous to calculate the difference in the radiation field strength as a percentage. In different embodiments, a substantially higher radiation field strength is a radiation field strength that is 11% or more higher, 26% or more higher, 52% or more higher, 78% or more higher, 102% or more higher, 152% or more higher, 202% or more higher, 252% or more higher, and even 303% or more higher. For some applications, it may be advantageous to calculate the difference in the radiation field strength as the number of times that the radiation field strength is higher. In different embodiments, a substantially higher radiation field strength is a radiation field strength that is less than 9000 times higher, less than 980 times higher, less than 97 times higher, less than 48 times higher, less than 19 times higher, and even less than 9 times higher. The inventor has found that in some embodiments, it may be desirable to disregard points where the radiation field strength is below a certain value. In different embodiments, the points with a radiation field strength below 99 V/m, below 25 V/m, below, 9 V/m, below 4 V/m, and even below 0.8 V/m are not used to calculate the number of times that the radiation field strength is substantially higher. Unless otherwise indicated, the feature “no significant difference” is defined throughout this document in the form of different alternatives that are explained in detail below. In an embodiment, no significant difference is a difference of 96% or less. In an alternative embodiment, no significant difference is a difference of 47% or less. In another alternative embodiment, no significant difference is a difference of 19% or less. In another alternative embodiment, no significant difference is a difference of 12% or less. In another alternative embodiment, no significant difference is a difference of 3% or less. In another alternative embodiment, no significant difference is a difference of 0.9% or less. All the embodiments disclosed above can be combined among them and with any other embodiment disclosed in this document in any combination provided that they are not mutually exclusive, for example, in an embodiment, at a first point in time in step 2, there is a first subset of points in the powder bed which is exposed to a radiation field strength 26% or more higher than a second subset of points in the powder bed; and wherein at a second point in time in step 2, the second subset of points in the powder bed is exposed to a radiation field strength 26% or more higher than the first subset of points in the powder bed, wherein the second point in time is later than the first point in time; or for example in another embodiment, at a first point in time in step 2, there are a first and a second subset of points in the powder bed which are exposed to a radiation field strength 26% or more higher than a third subset of points in the powder bed; and wherein at a second point in time in step 2, the second and third subset of points in the powder bed are exposed to a radiation field strength 26% or more higher than the first subset of points in the powder bed, wherein the second point in time is later than the first point in time; or for example in another embodiment, at a first point in time in step 2, there is a first subset of points in the powder bed which is exposed to a radiation field strength 26% or more higher than a second subset of points in the powder bed; and wherein at a second point in time in step 2, the difference between the radiation field strength to which the first and second subset of points are exposed is 19% or less, wherein the second point in time is later than the first point in time; or for example, in another embodiment, at a first point in time in step 2, there is a first subset of points in the powder bed which is exposed to a radiation field strength 26% or more higher than a second subset of points in the powder bed; wherein at a second point in time in step 2, the difference between the radiation field strength to which the first and second subset of points are exposed is 19% or less; and wherein at a third point in time in step 2, the second subset of points in the powder bed is exposed to a radiation field strength 26% or more higher than the first subset of points in the powder bed, wherein the second point in time is later than the first point in time, and the third point in time is later than the second point in time; or for example in another embodiment, at a first point in time in step 2, there is a first subset of points in the powder bed which is exposed to a radiation field strength 26% or more higher than a second subset of points in the powder bed; wherein at a second point in time in step 2, the difference in the radiation field strength to which the first and second subset of points are exposed is less than 19%; wherein at a third point in time in step 2, the second subset of points in the powder bed is exposed to a substantially higher radiation field strength than the first subset of points in the powder bed; and wherein at a fourth point in time in step 2, the first subset of points in the powder bed is exposed to a radiation field strength 26% or more higher than the second subset of points in the powder bed, wherein the second point in time is later than the first point in time, the third point in time is later than the second point in time and the fourth point in time is later than the third point in time. For certain applications of the method, the use of radiation comprising electromagnetic radiation may be advantageous. In an embodiment, the radiation field strength comprises electromagnetic radiation.

In some embodiments, the method comprises the use of radiation emitters which may be located in different parts of the chamber. In an embodiment, the method comprises the use of at least 2 radiation emitters. The inventor has found that for some applications, the number of radiation emitters used to apply the proper radiation (as defined in this document) may be relevant. In an embodiment, the proper radiation is applied using one or more than one radiation emitters. In another embodiment, the proper radiation is applied using at least two radiation emitters. For some applications, it may be advantageous to use more than one radiation emitter, particularly when the proper radiation comprises high wavelength radiation (as defined in this document). In an embodiment, the proper radiation is microwave radiation applied using at least two radiation emitters. In another embodiment, the proper radiation is Tera Hertz radiation applied using at least two radiation emitters. For some applications, the frequency of the radiation may be relevant. In an embodiment, the proper radiation is applied using at least 2 different frequencies. For some applications, it may be advantageous to use multiple radiation emitters at different frequencies. In an embodiment, the proper radiation is applied using at least 2 radiation emitters at different frequencies. For some applications, the location of the emitters in the chamber may be relevant. In an embodiment, the radiation emitters are located in different geometrical areas of the chamber.

Optionally, the method may further comprise other additional steps which may be performed before, during and/or after any of steps 1 to 6. In an embodiment, the method further comprises changing the volume of the chamber. In an embodiment, the method further comprises changing the position of the radiation source. In an embodiment, the method further comprises changing the position of the radiation emitters. In an embodiment, the method further comprises changing the frequency of the applied radiation.

For certain applications, the irradiance applied to the powder bed may be relevant. In different embodiments, the irradiance is 0.2 W/cm² or more, 2.2 W/cm² or more, 4.6 W/cm² or more, 5.2 W/cm² or more, 11 W/cm² or more, and even 55 W/cm² or more. On the other hand, excessive irradiance may be detrimental for some applications. In different embodiments, the irradiance is 980 W/cm² or less, 90 W/cm² or less, 49 W/cm² or less, and even below 9 W/cm² or less. All the embodiments disclosed above can be combined among them and with any other embodiment disclosed in this document in any combination provided that they are not mutually exclusive, for example, in an embodiment, the irradiance is between 0.2 and 980 W/cm².

In the present invention, it may be possible to use any high wavelength radiation modulation/“shaping” system, in fact any system capable of generating or changing the location of areas of different electromagnetic field intensity and which can operate with high wavelength radiation (filters, hologram generators, interference plates, moving meshes, diffractors, etc.). In an embodiment, the radiation is selectively modulated through a filter and/or a high wavelength radiation hologram generator.

In most applications of the present invention, and specially for complex geometries, while it is not too difficult to find a sequence of holograms leading to the desired geometry, such sequence might be much longer than needs be, and since sustainability is a main aspect for the present invention, the pursue for the most sustainable hologram sequence is often a priority. In an embodiment, the method comprises the use of holograms. Since in most executions of the present invention, there are several control variables (settings that can be varied in a controlled way of parameters affecting the location and intensity of the points with electromagnetic field intensity above a certain threshold, like: number of emitters active, position of emitters, frequency in each emitter, power in each emitter, powder bed location, reflector blade location, chamber geometry [blade location, reflector position, etc], magnetic field enhancement in each of the high wavelength radiation stoppers [often waveguides], number of stoppers active, direction of stoppers, interference plates position, filter instantaneous configuration, diffractors instantaneous configuration, etc) there are a vast number of combinations of such control variables leading to a huge number of possible holograms. To choose an optimised sequence of holograms leading to the desired component with the minimum amount of energy wasted, for many applications of the present invention the use of algorithms defining the sequence and each hologram within the sequence is often desirable. In an embodiment, method comprises the use of algorithms defining the sequence and each hologram within the sequence. In an embodiment, the method comprises the use of algorithms to generate the sequence of control variables which generates the sequence of holograms. Often in such cases every hologram corresponds to a certain configuration of all control variables. For some applications the use of artificial intelligence for the sequencing has also proven advantageous. In an embodiment, the method comprises the use of artificial intelligence to generate the sequence of control variables which generates the sequence of holograms. In some cases, the Machine Learning transformation from the ‘input vector’ (particular combinations of control variable values) to the ‘scalar’ output (energy field map) is not straightforward invertible, and the inventor has seen that in such cases a clustering of the ‘input vectors’ can be of great help.

In an embodiment, the irradiance is applied into the powder bed as a 2D or 3D pattern. One possible way to create the 3D radiation field is through the creation of patterns of interference, for example with a grid of tunable crystals or mirrors in a DLP like wafer. This can be done for example, with two or more wafers launching 2D light fields with different angles into the of the powder bed and causing the consolidation of particles where constructive interference occurs. In an embodiment, each wafer projects light with different wavelengths. In an embodiment, the same effect is attained with a single wafer. For some applications, the materials used have to be picked to have a high reflectivity index for the radiation of interest chosen. For example, in the case of Tera Hertz (or close to Tera Hertz) radiation, gold and silver are good candidates as are aluminum and copper, among many others. In different embodiments, the reflectivity index should be 82% or greater, 86% or greater, 92% or greater, 96% or greater, and even 99% or greater for the radiation of interest. In different embodiments, the reflectivity index should be 82% or greater, 86% or greater, 92% or greater, 96% or greater, and even 99% or greater for the whole radiation spectra of the source used. Often, the radiation may be chosen so there is no linear absorption by the particles. Radiation interference patterns may be generated below the surface of the powder bed. For some applications, it may be advantageous to use patterns that change over time.

In an embodiment, the proper radiation resonates in confined areas. In an embodiment, the effective volume in which resonance occurs is 89% or less, 49% or less, 19% or less, 9% or less, 0.9% or less and even 0.08% or less of the irradiated volume in the powder bed. The inventor has found that for some applications, it may be particularly relevant to choose a wavelength, such that resonance effects are maximized. In an embodiment, the wavelength is chosen such that resonance effects are present. In another embodiment, the wavelength is chosen such that resonance effects are attained with the right size of the particles. In another embodiment, the wavelength is chosen such that resonance effects are attained with the right size of the voids between the particles.

For certain applications of the method, it may be particularly advantageous to apply a magnetic field, particularly when the particles comprise ferromagnetic materials. In an embodiment, a magnetic field is applied orthogonal to the direction of propagation of the radiation. In an embodiment, a magnetic field is applied between 45° and 135° to the direction of propagation of the radiation. In another embodiment, a magnetic field is applied parallel to the direction of propagation of the radiation. In another embodiment, a magnetic field is applied between 30° and −30° to the direction of propagation of the radiation. Throughout this paragraph the feature “radiation” is defined in the form of different alternatives that are explained in detail below. In an embodiment, the radiation refers to the proper radiation (as defined in this document). In an alternative embodiment, the radiation refers to the relevant radiation.

Optionally, the printed component obtained after applying the method disclosed in the preceding paragraphs may be removed from the chamber, placed in a post-processing device and further subjected to a variety of treatments including, but not limited to, pressure and/or temperature treatments, debinding treatments, consolidation treatments, infiltration treatments, densification treatments, thermo-mechanical treatments and/or machining, among others. In some embodiments, the treatments disclosed in patent application number WO2021165545A1, the contents of which are incorporated herein by reference in their entirety, may be advantageously applied.

For some applications, it may be advantageous to manufacture the components in different parts that can be assembled together. In an embodiment, the method further comprises the step of: assembling the component to other parts, pieces or components. Additionally or alternatively, it may also be advantageous to manufacture the components from different materials. In an embodiment, the components are made of at least two different materials. In another embodiment, the components are made of at least three different materials.

It should be understood that in certain embodiments, one or more of the method steps described in the preceding paragraphs may be performed in a different order (or even simultaneously) without altering the principles of the method described.

Another aspect of the invention refers to the components manufactured using the method disclosed above. Some examples of the components that may advantageously be manufactured with this method include, but are not limited to, pieces, large structured components, particularly those with high solicitations, power transmission elements, tools, power generation/transformation elements, components for the transportation industry, components for the aerospace industry, components for the rail transportation industry, components for the automotive industry, components for the marine transportation industry, components for the food processing industry, components for the pharmaceutical industry, components for the packaging industry, components for the electronics industry, components for the appliance industry, components for the material transformation industry, dies and/or molds, among others.

Another aspect of the invention relates to an apparatus for the additive manufacturing of components, in particular an apparatus for the volumetric printing of components through holograms, the apparatus comprising:
a chamber in which a three-dimensional component is additively manufactured;
a powder holder for holding a powder bed;
at least one radiation generator; and
at least one radiation applicator per generator.

The apparatus may include additional components, some of which are described in this document.

The chamber may be configured to hold a powder bed disposed therein, for example in a powder holder (e.g., a platform, build platform, build plate, printing bed, tank, container, . . . ). For some applications, it may be advantageous to use a closed chamber. In an embodiment, the chamber is closed after introducing the powder. In another embodiment, the chamber is closed and sealed after introducing the powder. For some applications, it may be advantageous to use a high pressurized chamber. In different embodiments, a high pressurized chamber means a chamber pressurized with a fluid to 1200 bar or more, 2100 bar or more, 2600 bar or more, 3010 bars or more, 3800 bar or more and even 4200 bar or more. Different types of atmospheres can be advantageously used including, but not limited to, a normal atmosphere (air), an inert atmosphere (e.g., helium, argon, . . . ), a protective atmosphere, a reactive atmosphere (e.g., reducing atmosphere, . . . ), and/or mixtures thereof.

The inventor has found that chambers with different geometric shapes may be employed. In this regard, the apparatus for the volumetric printing may comprise a chamber with different geometric shapes including, but not limited to, cylindrical, square, rectangular, polygonal, cubic, cuboidal, pyramidal, pentagonal, hexagonal, octahedral, ellipsoidal, spherical, and/or conical. However, the geometry of the chamber is not limited to the geometries described above. For some applications, it may be advantageous to use the chamber as a resonator of the wavelength employed. In an embodiment, the chamber acts as a resonator of the wavelength. For some applications, it may be particularly advantageous to use a chamber with a cylindrical shape. In an embodiment, the chamber is cylindrical. In another embodiment, the chamber is cylindrical, with some metal plates in a hexahedral positioning to enhance the resonance. In another embodiment, the chamber is cylindrical, with some metal plates in a heptahedral positioning to enhance the resonance. In another embodiment, the chamber is cylindrical, with some metal plates in an octahedral positioning to enhance the resonance. In another embodiment, the chamber is cylindrical, with some metal plates in a dodecahedral positioning to enhance the resonance. In another embodiment, the chamber is cylindrical, with some metal plates in a polygonal positioning to enhance the resonance. In another embodiment, the chamber is cylindrical, with some metal plates in a triangular positioning to enhance the resonance. The inventor has found that for some applications, it may be particularly advantageous to provide the apparatus with a system for changing the dimensions of the chamber. In an embodiment, the chamber changes its dimensions.

For some applications, it may be advantageous to use a mobile system. In an embodiment, the chamber comprises a mobile system (in the meaning of this document, the mobile system refers to the mechanism used to produce a movement). In an embodiment, the mobile system comprises an electric motor. In an embodiment, the mobile system produces a movement in the horizontal plane. In an embodiment, the mobile system produces a movement in the vertical plane. In an embodiment, the mobile system produces a rotational movement. For some applications, a complex movement is preferred. In an embodiment, the mobile system produces a movement in more than one plane. In some applications, the mobile system may be located inside the chamber.

The inventor has found that different types of radiation may be advantageously applied. Different radiation generators may be advantageously used. In an embodiment, the proper radiation is generated with a solid-state generator. For some applications, it may be advantageous to use more than one radiation generator. In different embodiments, at least 1, at least 2, at least 4, at least 6 and even at least 8 radiation generators are used. In some applications, the number of generators should be limited. In different embodiments, less than 19, less than 14, less than 9 and even less than 4 radiation generators are used. All the embodiments disclosed above can be combined among them and with any other embodiment disclosed in this document in any combination provided that they are not mutually exclusive, for example, in an embodiment, the method comprises the use of between 1 and 19 radiation generators. For some applications, it may be advantageous to use multiple microwave generators. In an embodiment, the proper radiation is generated with a solid-state microwave generator. In different embodiments, at least 1, at least 2, at least 4, at least 6 and even at least 8 microwave generators are used. In some applications, the number of microwave generators should be limited. In different embodiments, less than 19, less than 14, less than 9 and even less than 4 microwave generators are used. All the embodiments disclosed above can be combined among them and with any other embodiment disclosed in this document in any combination provided that they are not mutually exclusive, for example, in an embodiment, the method comprises the use of between 1 and 19 microwave generators.

For some applications, the total power of the radiation generators employed may be relevant. In different embodiments, the total power used is 55 W or more, 155 W or more, 355 W or more, 555 W or more, 1055 W or more and even 3055 W or more. For some applications, it has been found to be more efficient to control the total power employed. In different embodiments, the total power used is 55000 W or less, 19000 W or less, 9000 W or less, 3900 W or less and even 900 W or less. All the embodiments disclosed above can be combined among them and with any other embodiment disclosed in this document in any combination provided that they are not mutually exclusive, for example, in an embodiment, the total power of the generators employed is between 55 and 55000 W; or for example in another embodiment, the total power of the microwave generators employed is between 55 and 55000 W.

For some applications, it may be of particular interest to use more than one applicator as the proper radiation source. In different embodiments, at least 2, at least 3, and even at least 4 applicators are used as the proper radiation source. For some applications, the number of applicators should be limited. In different embodiments, less than 990, less than 59 and even less than 19 applicators are used as the proper radiation source. In an embodiment, the applicator comprises an antenna. In another embodiment, the applicator is an antenna The inventor has found that for some applications, the use of more than one microwave applicator located inside the chamber may surprisingly reduce the distortion of the manufactured components. In different embodiments, at least 2, at least 3, and even at least 4 microwave applicators are used. For some applications, the number of microwave applicators should be limited. In different embodiments, less than 990, less than 59 and even less than 19 microwave applicators are used. In an embodiment, the microwave applicator comprises an antenna. In another embodiment, the microwave applicator is an antenna. All the embodiments disclosed above can be combined among them and with any other embodiment disclosed in this document in any combination provided that they are not mutually exclusive, for example, in an embodiment, the proper radiation is applied using between 2 and 990 microwave applicators.

For some applications, it may be advantageous to use several radiation applicators per generator. In different embodiments, the generator comprises at least 2, at least 4, at least 6 and even at least 8 radiation applicators. For some applications, the number of applicators per generator should be limited. In different embodiments, the generator comprises less than 19, less than 14, and even less than 4 radiation applicators. For some applications, the use of several microwave applicators per generator may be advantageous. In different embodiments, the generator comprises at least 2, at least 4, at least 6 and even at least 8 microwave applicators. For some applications, the number of microwave applicators per generator should be limited. In different embodiments, the generator comprises less than 19, less than 14, and even less than 4 microwave applicators. All the embodiments disclosed above can be combined among them and with any other embodiment disclosed in this document in any combination provided that they are not mutually exclusive, for example, in an embodiment, the number of microwave applicators per generator is between 2 and 19. In an embodiment, the generator is located inside the chamber. In another embodiment, the generator is located outside of the chamber. In an embodiment, the generator is a magnetron.

For some applications, the manner in which the radiation is introduced into the chamber may be relevant. In an embodiment, a high-pressure resistant magnetron is introduced into the chamber. In another embodiment, only the antenna of the magnetron is introduced into the chamber, provided with a pressure resistant shield and properly sealed. In an embodiment, the connection between the anode of the magnetron and the antenna is interrupted with a feedthrough to enter the chamber, having the antenna in the high-pressure region and the rest of the magnetron outside.

For some applications, the manner in which the generator is connected may be relevant. In an embodiment, the generator is connected to a coaxial feedthrough in one of the walls of the chamber through a coaxial cable. For some applications, the manner in which the microwave generator is connected may be relevant. In an embodiment, the microwave generator is connected to a coaxial feedthrough in one of the walls of the chamber through a coaxial cable. In an embodiment, an antenna or applicator is connected at the high-pressure side of the coaxial feedthrough.

For some applications, it may be relevant to use a coaxial cable or coaxial feedthrough with the proper dimensions. In an embodiment, the coaxial cable has the proper dimensions. In another embodiment, the coaxial feedthrough has the proper dimensions. In different embodiments, the proper dimensions mean a nominal outer diameter (OD) of 7/32″ or greater, of 7/16″ or greater, of ⅞″ or greater and even of 1⅝″ or greater. For some applications, the use of too large diameters may be detrimental. In different embodiments, the proper dimensions mean a nominal outer diameter (OD) of 4 1/16″ or less, of 3⅛″ or less and even of 1⅝″ or less. For some applications, the use of a coaxial cable or coaxial feedthrough with the proper impedance may be relevant. In an embodiment, the coaxial feedthrough has the proper impedance. In another embodiment, the coaxial cable has the proper impedance. In different embodiments, the proper impedance means an impedance of 1.1 ohms or more, of 11 ohms or more, of 21 ohms or more and even of 41 ohms or more. For some applications, high values may be detrimental. In different embodiments, the proper impedance means an impedance of 199 ohms or less, of 150 ohms or less, of 99 ohms or less, of 69 ohms or less and even of 49 ohms or less. All the embodiments disclosed above can be combined among them and with any other embodiment disclosed in this document in any combination provided that they are not mutually exclusive, for example, in an embodiment, the coaxial feedthrough has an impedance between 1.1 and 199 ohms.

For some applications, the use of multiple coaxial feedthrough entry points to the chamber may be advantageous. In different embodiments, the chamber comprises more than 2, more than 4, more than 6, and even more than 8 coaxial feedthrough entry points. For some applications, the number of coaxial feedthrough entry points to the chamber should be limited. In different embodiments, the chamber comprises less than 19, less than 14, less than 9 and even less than 4 coaxial feedthrough entry points. All the embodiments disclosed above can be combined among them and with any other embodiment disclosed in this document in any combination provided that they are not mutually exclusive, for example, in an embodiment, the chamber comprises more than 2 and less than 19 coaxial feedthrough entry points.

The inventor has found that for some applications, the use of a high electric potential feedthrough may be advantageous. In different embodiments, a high electric potential is an electric potential greater than 600 V, greater than 1200 V, greater than 2200 V, greater than 4200 V, greater than 5200 V and even greater than 11200 V. For some applications, the electric potential should be limited. In different embodiments, a high electric potential is an electric potential of less than 190000 V, of less than 140000 V, of less than 110000 V, of less than 90000 V, of less than 49000 V, of less than 19000 V and even of less than 9000 V. In an embodiment, the use of terms such “below”, “above”, “or more”, “from”, “up to”, “at least”, “greater than”, “higher than”, “more than”, “less than” and the like throughout the disclosure, include the number recited. All the embodiments disclosed above can be combined among them and with any other embodiment disclosed in this document in any combination provided that they are not mutually exclusive, for example, in an embodiment, the apparatus comprises a feedthrough with an electric potential between 600 and 190000 V.

The inventor has found that for some applications the use of a high apparent power feedthrough may be advantageous. In different embodiments, a high apparent power is an apparent power greater than 1200 VA, greater than 6200 VA, greater than 11000 VA, greater than 26000 VA, greater than 52000 VA and even greater than 110000 VA. For some applications, the apparent power should be limited. In different embodiments, a high apparent power is an apparent power of less than 990000 VA, of less than 440000 VA, of less than 240000 VA, of less than 190000 VA, of less than 110000 VA, of less than 89000 VA and even of less than 49000 VA. All the embodiments disclosed above can be combined among them and with any other embodiment disclosed in this document in any combination provided that they are not mutually exclusive, for example, in an embodiment, the apparatus comprises a feedthrough with an apparent power between 1200 and 990000 VA.

The inventor has found that for some applications the use of a high power feedthrough may be advantageous. In different embodiments, a high power is a power greater than 1100 W, greater than 5600 W, greater than 10100 W, greater than 23600 W, greater than 46800 W and even greater than 960000 W. For some applications, the power should be limited. In different embodiments, a high power is a power of less than 890000 W, of less than 394000 W, of less than 214000 W, of less than 169000 W, of less than 79000 W and even of less than 44000 W. All the embodiments disclosed above can be combined among them and with any other embodiment disclosed in this document in any combination provided that they are not mutually exclusive, for example, in an embodiment, the apparatus comprises a feedthrough with an power between 1100 and 890000 W.

For some applications, it may be particularly advantageous to use a radiation source mounted in a system that can be moved to generate the desired patterns. In an embodiment, the radiation source is mounted in a system that changes its position. For some applications, it may be advantageous to change the position of the radiation source. In an embodiment, the radiation source is displaced in the chamber. The movement of the radiation source may be made in different planes. In an embodiment, the movement of the radiation source is made in the horizontal plane. In another embodiment, the movement of the radiation source is made in the vertical plane. In another embodiment, the movement of the radiation source is rotational. For some applications, a complex movement may be preferred. In an embodiment, the movement of the radiation source is made in more than one plane. For some applications, it may be advantageous to change the position of the component which is being manufactured. In an embodiment, the movement of the component which is being manufactured is made in the horizontal plane. In another embodiment, the movement of the component which is being manufactured is made in the vertical plane. In another embodiment, the movement of the component which is being manufactured is rotational. For some applications, a complex movement may be preferred. In an embodiment, the movement of the component which is being manufactured is made in more than one plane.

The inventor has found that some applications may benefit from the use of at least one element to reflect the radiation. For some applications, the use of a mobile system comprising blades for reflecting the radiation may be particularly advantageous. In an embodiment, the apparatus comprises blades. In another embodiment, the mobile system comprises blades that reflect the radiation. For some applications, the use of a mobile system comprising blades for reflecting the microwave radiation may be particularly advantageous. In an embodiment, the apparatus comprises blades. In another embodiment, the mobile system comprises blades which reflect the microwaves. For example, the blades may be made of various materials including, but not limited to, steel, stainless steel, tempered steel, metal-based alloys and/or combinations thereof. In an embodiment, the blades are made of metal. In another embodiment, the blades are made of a polished sheet of metal. In an embodiment, the method comprises the use of rotating blades.

The inventor has found that some applications may benefit from the use of glowing materials (as described below). For some applications of the method, it may be advantageous when the method is performed in a chamber which further comprises glowing materials (e.g., glowing particles) applied to an element contained in the chamber. In an embodiment, the chamber comprises glowing materials. In an embodiment, the glowing materials are applied to an element contained in the chamber (hereinafter referred to as the element supporting the glowing materials). In an embodiment, the glowing materials are applied to the inner surface of the element supporting the glowing materials. The glowing materials may be applied by using any available technology. In an embodiment, the glowing materials are applied in powder form. In an embodiment, the glowing materials are sprayed. In an embodiment, the glowing materials are sprayed in powder form. In an embodiment, at least part of the inner surface of the element supporting the glowing materials is sprayed with the glowing materials. The inventor has found that for some applications the use of glowing materials comprising at least a metal is preferred. In an embodiment, the glowing materials comprise an alloy. In an embodiment, the glowing materials comprise a metallic alloy. In an embodiment, the glowing materials comprise a molybdenum alloy. In an embodiment, the glowing materials comprise a tungsten alloy. In an embodiment, the glowing materials comprise a tantalum alloy. In an embodiment, the glowing materials comprise a zirconium alloy. In an embodiment, the glowing materials comprise a nickel alloy. In an embodiment, the glowing materials comprise an iron-based alloy. In an embodiment, the glowing materials comprise a material with a high dielectric loss in frequency range of interest. For some applications, the use of glowing materials comprising carbides is preferred. In an embodiment, the glowing materials comprise titanium carbides (TiC). For some applications, the use of glowing materials comprising borides is preferred. In an embodiment, the glowing materials comprise a barium titanate (BaTiO₃). In an embodiment, the glowing materials comprise a strontium titanate (SrTiO₃). In an embodiment, the glowing materials comprise a barium-strontium titanate (Ba, Sr (TiO₃)). The element supporting the glowing materials may have different geometric shapes. In an embodiment, the chamber comprises an element supporting the glowing materials. In an embodiment, the element supporting the glowing materials has a cylindrical shape. In another embodiment, the element supporting the glowing materials has a square shape. In another embodiment, the element supporting the glowing materials has a rectangular shape. In another embodiment, the element supporting the glowing materials has a spherical shape. In another embodiment, the element supporting the glowing materials has a conical shape. In another embodiment, the element supporting the glowing materials has an irregular geometric shape.

For some applications, the radiation applicator, the generator and/or the antenna may be located inside the element supporting the glowing materials. In an embodiment, the radiation applicator is located inside the element supporting the glowing materials. In an embodiment, the antenna is located inside the element supporting the glowing materials. For some applications, the generator may also be located inside the element supporting the glowing materials, although it is usually preferable to have the generator located outside of the chamber. For some applications, it may be advantageous to use an element supporting the glowing materials made of high temperature resistant materials. In an embodiment, the element supporting the glowing materials is made of a material comprising an alloy. In another embodiment, the element supporting the glowing materials is made of a material comprising a metallic alloy. In another embodiment, the element supporting the glowing materials is made of a material comprising a molybdenum alloy. In another embodiment, the element supporting the glowing materials is made of a material comprising a tungsten alloy. In another embodiment, the element supporting the glowing materials is made of a material comprising a tantalum alloy. In another embodiment, the element supporting the glowing materials is made of a material comprising a zirconium alloy. In another embodiment, the element supporting the glowing materials is made of a material comprising a ceramic. In another embodiment, the element supporting the glowing materials is made of a material comprising a nickel alloy. In another embodiment, the element supporting the glowing materials is made of a material comprising an iron-based alloy. In another embodiment, the element supporting the glowing materials is made of a material with a high dielectric loss in the desired frequency range. For some applications, the use of a material comprising carbides may be preferred. In an embodiment, the element supporting the glowing materials is made of a material comprising titanium carbides (TiC). For some applications, the use of a material comprising borides may be preferred. In an embodiment, the element supporting the glowing materials is made of a material comprising a barium titanate (BaTiO₃). In another embodiment, the element supporting the glowing materials is made of a material comprising a strontium titanate (SrTiO₃). In another embodiment, the element supporting the glowing materials is made of a material comprising a barium-strontium titanate (Ba, Sr (TiO₃)). In some embodiments, it may also be advantageous to use a mixture comprising at least two of the materials disclosed above, for example an element supporting the glowing materials made of a material comprising a tungsten alloy and a molybdenum alloy.

The inventor has found that for some applications the use of radiation shields may be advantageous. In an embodiment, the chamber comprises a radiation shield. The radiation shields may have different geometric shapes. In an embodiment, the radiation shield and the element supporting the glowing materials have the same geometric shape. In an embodiment, the radiation shield and the element supporting the glowing materials have the same geometric shape but differ in size. In an embodiment, the radiation shield has a cylindrical shape. In another embodiment, the radiation shield has a square shape. In another embodiment, the radiation shield has a rectangular shape. In another embodiment, the radiation shield has a spherical shape. In another embodiment, the radiation shield has a conical shape. In another embodiment, the radiation shield has an irregular geometric shape. In an embodiment, the radiation shield and the element supporting the glowing materials are concentrically disposed with respect to each other. In another embodiment, the radiation shield and the element supporting the glowing materials are concentrically disposed with respect to the vertical axis. For some applications, it may be advantageous to use more than one radiation shield. In different embodiments, the chamber comprises at least 1, at least 2, at least 4 and even at least 6 radiation shields. For some applications, the number of radiation shields should be limited. In different embodiments, the chamber comprises less than 99, less than 49, less than 19 and even less than 9 radiation shields. For some applications, the disposition of the radiation shields may be relevant. In an embodiment, the radiation shields are concentric with each other. In an embodiment, the radiation shields are disposed concentrically about the vertical axis. The inventor has found that for some applications, it may be advantageous to use radiation shields made of metallic materials. In an embodiment, the radiation shield is made of a material comprising an alloy. In another embodiment, the radiation shield is made of a material comprising a metallic alloy. In another embodiment, the radiation shield is made of a material comprising a tungsten alloy. In another embodiment, the radiation shield is made of a material comprising a molybdenum alloy. In another embodiment, the radiation shield is made of a material comprising a tantalum alloy. For some applications the use of high wavelength (as defined in this document) shields may be advantageous. In an embodiment, the method comprises the use of high wavelength radiation shields.

The apparatus may comprise other elements, such as for example, but not limited to: a motor, an inhibitor liquid detector, a system for heating the powder in the powder bed, a system for heating the polymer or slurry bed, a powder dispenser, a powder supply device, a liquid dispenser, etc.

All the embodiments disclosed in this document can be combined among them and with any other embodiment disclosed in this document in any combination, provided that they are not mutually exclusive. Some non-limiting examples of embodiment combinations are as follows: [1] A method for the additive manufacturing of components, in particular a method for the volumetric printing of components through holograms, comprising the following steps: Step 1: providing a powder bed comprising at least one layer of powder; Step 2: exposing at least part of the powder bed to radiation to consolidate only part of the powder in the powder bed; Step 3: optionally, providing an additional layer of powder adjacent to the previously consolidated or at least partially consolidated layer of powder to form successive powder layers of the powder bed; Step 4: optionally, repeating step 2; Step 5: optionally, repeating steps 3 and 4 until the component is completely additively manufactured; and Step 6: separating the consolidated or partially consolidated powder from the unconsolidated powder in the powder bed. [2] The method according to [1], wherein the part of the powder exposed to the radiation in step 2 is constrained to the uppermost layer of powder added. [3] The method according to [1], wherein the part of the powder exposed to the radiation in step 2 is constrained to the two uppermost layers of powder added. [4] The method according to [1], wherein the part of the powder exposed to the radiation in step 2 is constrained to some, but not all, of the plurality of powder layers in the powder bed. [5] The method according to any of [1] to [4], wherein the part of the powder that is consolidated in step 2 is constrained to the uppermost layer of powder added. [6] The method according to any of [1] to [4], wherein the part of the powder that is consolidated in step 2 is constrained to the two uppermost layers of powder added. [7] The method according to any of [1] to [4], wherein the part of the powder that is consolidated in step 2 is constrained to some, but not all, of the plurality of powder layers in the powder bed. [8] The method according to any of [1] to [7], wherein step 2 comprises consolidating at least part of the additional layer of powder provided with at least part of the previously consolidated or at least partially consolidated layer of powder. [9] The method according to any of [1] to [8], wherein consolidation takes place at a temperature below the temperature at which sintering or melting occurs. [10] The method according to any of [1] to [9], wherein when applying step 2, there is a zone of the powder bed where the radiation field strength is below the radiation field strength that produces consolidation, so that no consolidation takes place. [11] The method according to [10], wherein the zone in the powder bed where no consolidation takes place coincides with the previously consolidated or at least partially consolidated layers of powder. [12] The method according to any of [10] to [11], wherein the radiation field strength is below the radiation field strength that produces consolidation, because the radiation is substantially stopped or slowed down. [13] The method according to any of [1] to [12], wherein consolidation is impeded in zones where at least part of the powder bed was previously consolidated, through the use of magnetic fields. [14] The method according to any of [10] to [13], wherein the radiation in the zones of the powder bed where consolidation does not take place is stopped or slowed down using an extremely enhanced magnetic field. [15] The method according to [14], wherein an extremely enhanced magnetic field is a magnetic field with an amplitude between 110 and 10⁸ V/m. [16] The method according to any of [1] to [15], wherein the radiation is stopped or slowed down using one or more microwave one-way waveguides. [17] The method according to any of [1] to [16], wherein the radiation is selectively modulated through a filter and/or a radiation hologram generator with a wavelength between 0.00008 and 59 cm. [18] The method according to any of [1] to [17], wherein a filter and/or a radiation hologram generator with a wavelength between 0.00008 and 59 cm generates a holographic image of points with a radiation field intensity at least 20% higher than the mean radiation intensity of all the points in the powder bed, wherein the points in the powder bed exposed to a radiation field intensity of 0.8 V/m or less are excluded to calculate the mean radiation intensity, this holographic image of points being generated in the chamber where the powder bed is located. [19] The method according to any of [1] to [18], wherein a filter and/or a radiation hologram generator with a wavelength between 0.00008 and 59 cm generates a holographic image of points with a radiation field intensity of 0.8 V/m or more, this holographic image of points being generated in the chamber where the powder bed is located. [20] The method according to any of [1] to [19], wherein said method comprises the use of holograms. [21] The method according to [20] wherein when the duration of the exposition of a point of the powder bed to a particular hologram is short enough or when that point is not exposed to a high enough radiation field strength, then the consolidation does not occur, but when that point is exposed a second time to a sufficiently high radiation field intensity, then consolidation occurs. [22] The method according to any of [1] to [21], wherein said method comprises the use of between 3 and 1000 pulses to produce consolidation in a point of the powder bed. [23] The method according to any of [1] to [22], wherein said method comprises the use of between 3 and 1000 pulses within the right time to produce consolidation in a point of the powder bed. [24] The method according to any of [1] to [23], wherein said method comprises the use of a sequence of holograms. [25] The method according to any of [1] to [24], wherein the sequence of holograms is generated by selecting the sequence of control variables. [26] The method according any of [24] to [25], wherein said method comprises the use of algorithms to generate the sequence of control variables which generates the sequence of holograms. [27] The method according to any of [1] to [26], wherein said method comprises the use of algorithms defining the sequence and each hologram within the sequence. [28] The method according to any of [24] to [27], wherein said method comprises the use of artificial intelligence to generate the sequence of control variables which generates the sequence of holograms. [29] The method according to any of [24] to [28], wherein said method comprises the use of machine learning to generate the sequence of control variables which generates the sequence of holograms. [30] The method according to any of [24] to [29], wherein said method comprises the use of machine learning trained with a transformation from the input vector, containing all the possible combinations of the control variables and the scalar output, which is the degree of consolidation map comprising the value for each point in the powder bed, to generate the sequence of values for each control variable that generates the sequence of holograms. [31] The method according to any of [24] to [30], wherein said method comprises the use of machine learning trained with a transformation from the input vector, containing all the possible combinations of the control variables and the scalar output, which is the radiation field intensity map comprising the value for each point in the powder bed, to generate the sequence of values for each control variable that generates the sequence of holograms. [32] The method according to any of [29] to [31], wherein after the training of the machine learning system, the transformation is inverted. [33] The method according to [32], wherein clustering of the input vectors is applied to facilitate the inversion of the transformation. [34] The method according to any of [1] to [33], wherein said method comprises modelling the consolidation level reached by every point in the powder bed. [35] The method according to any of [1] to [34], wherein said method comprises the use of a machine learning system to provide the control variable variation sequence, the machine learning system comprising the modelling of the consolidation level reached by every point in the powder bed. [36] The method according to any of [1] to [35], wherein said method comprises the use of a machine learning system to provide the time variation of each of the control variables, the machine learning system comprising the modelling of the consolidation level reached by every point in the powder bed. [37] The method according to any of [1] to [36], wherein said method comprises modelling the temperature level reached by every point in the powder bed. [38] The method according to any of [1] to [37], wherein said method comprises the use of a machine learning system to provide the control variable variation sequence, the machine learning system comprising the modelling of the temperature level reached by every point in the powder bed. [39] The method according to any of [1] to [38], wherein said method comprises the use of a machine learning system to provide the time variation of each of the control variables, the machine learning system comprising the modelling of the radiation accumulated energy level reached by every point in the powder bed. [40] The method according to any of [1] to [39], wherein said method comprises modelling the radiation accumulated energy level reached by every point in the powder bed. [41] The method according to any of [1] to [40], wherein said method comprises the use of a machine learning system to provide the control variable variation sequence, the machine learning system comprising the modelling of the radiation accumulated energy level reached by every point in the powder bed. [42] The method according to any of [1] to [41], wherein said method comprises the use of a machine learning system to provide the time variation of each of the control variables, the machine learning system comprising the modelling of the radiation accumulated energy level reached by every point in the powder bed. [43] The method according to any of [1] to [42], wherein the modelling comprises the amount of energy directly received by the point and the heat transmission to and from surrounding points. [44] The method according to any of [1] to [43], wherein the modelling is used in the simulation of such consolidation level for each point in the powder bed as a function of any value combination in the control variables and in turn using this simulation during the supervised training of the machine learning system. [45] The method according to any of [1] to [44], wherein in the machine learning system the input vector is constituted by the particular combinations of control variable values where clustering of input vectors is employed to favour the inversion of the transformation. [46] The method according to any of [1] to [45], wherein the machine learning system takes into account that the points of the powder bed belonging to the components to be manufactured have to reach a 100% consolidation value and the points of the powder bed which do not coincide with any component to be manufactured stay always below 50% consolidation value. [47] The method according to any of [1] to [46], wherein step 6 is performed after each exposure of the powder bed to the radiation and prior to providing an additional layer of powder in step 3. [48] The method according to any of [1] to [47], wherein there are points in the powder bed which are exposed to different radiation field strengths in step 2. [49] The method according to any of [1] to [48], wherein there are points in the powder bed which are exposed to a higher radiation field strength than other points in the powder bed at least at one point in time in step 2. [50] The method according to any of [1] to [49], wherein at a first point in time in step 2, there is a first subset of points in the powder bed which is exposed to a substantially higher radiation field strength than a second subset of points in the powder bed; and wherein at a second point in time in step 2, the second subset of points in the powder bed is exposed to a substantially higher radiation field strength than the first subset of points in the powder bed. [51] The method according to any of [1] to [50], wherein at a first point in time in step 2, there are a first and a second subset of points in the powder bed which are exposed to a substantially higher radiation field strength than a third subset of points in the powder bed; and wherein at a second point in time in step 2, the second and third subset of points in the powder bed are exposed to a substantially higher radiation field strength than the first subset of points in the powder bed. [52] The method according to any of [1] to [51], wherein at a first point in time in step 2, there is a first subset of points in the powder bed which is exposed to a substantially higher radiation field strength than a second subset of points in the powder bed; and wherein at a second point in time in step 2, there is no significant difference between the radiation field strength to which the first and second subset of points are exposed. [53] The method according to any of [1] to [52], wherein at a first point in time in step 2, there is a first subset of points in the powder bed which is exposed to a substantially higher radiation field strength than a second subset of points in the powder bed; wherein at a second point in time in step 2, there is no significant difference between the radiation field strength to which the first and second subset of points are exposed; and wherein at a third point in time in step 2, the second subset of points in the powder bed is exposed to a substantially higher radiation field strength than the first subset of points in the powder bed. [54] The method according to any of [1] to [53], wherein at a first point in time in step 2, there is a first subset of points in the powder bed which is exposed to a substantially higher radiation field strength than a second subset of points in the powder bed; wherein at a second point in time in step 2, there is no significant difference in the radiation field strength to which the first and second subset of points are exposed; wherein at a third point in time in step 2, the second subset of points in the powder bed is exposed to a substantially higher radiation field strength than the first subset of points in the powder bed; and wherein at a fourth point in time in step 2, the first subset of points in the powder bed is exposed to a substantially higher radiation field strength than the second subset of points in the powder bed. [55] The method according to any of [50] to [54], wherein the second point in time is later than the first point in time. [56] The method according to any of [54] to [55], wherein the third point in time is later than the second point in time. [57] The method according to any of [54] to [56], wherein the fourth point in time is later than the third point in time. [58] The method according to any of [1] to [57], wherein the radiation comprises electromagnetic radiation. [59] The method according to any of [1] to [58], wherein the radiation field strength comprises electromagnetic radiation. [60] The method according to any of [50] to [59], wherein the points of each subset of points are not in every case adjacent to each other. [61] The method according to any of [50] to [60], wherein a subset of points consists of a number of points between 2 and 79000. [62] The method according to any of [18] to [61], wherein each point is a powder particle. [63] The method according to any of [18] to [61], wherein each point is a voxel. [64] The method according to [63], wherein the voxel is a polyhedron with cubic geometry and an edge length of 0.001 mm. [65] The method according to any of [50] to [64], wherein a substantially higher radiation field strength is a radiation field strength which is 26% or more higher. [66] The method according to any of [52] to [65], wherein no significant difference is a difference of 19% or less. [67] The method according to any of [1] to [66], wherein when the component is manufactured from a single layer or less than 10 layers of powder, the thickness of the layer or layers of powder provided is between 16 mm and 49 m. [68] The method according to any of [1] to [67], wherein when the component is manufactured from more than 10 layers of powder, the thickness of the layers of powder provided is between 0.4 microns and 49 cm. [69] The method according to any of [1] to [68], wherein the thickness of at least one of the layers of powder provided is different at different points of that layer. [70] The method according to any of [1] to [69], wherein the powder bed comprises layers of powder of different thicknesses. [71] The method according to any of [1] to [70], wherein the powder bed comprises a main component, the main component being the component with the highest weight percentage in the powder bed, wherein if there are two or more components with the same weight percentage that are the components with the highest weight percentage in the powder bed, then the main component is the component with the highest density among them, and if the two or more components with the highest weight percentage in the powder bed have the same density, then the main component is the component with the highest melting temperature among them. [72] The method according to any of [1] to [70], wherein the powder bed comprises a main component, the main component being the component with the highest volume percentage in the powder bed, wherein if there are two or more components with the same volume percentage that are the components with the highest volume percentage in the powder bed, then the main component is the component with the highest density among them, and if the two or more components with the highest volume percentage in the powder bed have the same density, then the main component is the component with the highest melting temperature among them. [73] The method according to any of [1] to [72], wherein the components are metallic components or at least partially metallic components. [74] The method according to any of [1] to [73], wherein the components are ceramic components or at least partially ceramic components. [75] The method according to any of [1] to [74], wherein the components are polymeric components or at least partially polymeric components. [76] The method according to any of [1] to [75], wherein the maximum temperature at which the powder bed is exposed in step 2 is less than 0.5*Tm, which is below the sintering and melting temperature of the powder, to which Tm refers to. [77] The method according to [76], wherein Tm is the melting temperature in Kelvin of the metallic powder in the powder bed with the highest melting point. [78] The method according to [76], wherein Tm is the melting temperature in degrees Kelvin of the metallic powder in the powder bed with the lowest melting point. [79] The method according to [76], wherein Tm is the melting temperature in degrees Kelvin of the metallic powder in the powder bed which is the main component. [80] The method according to [76], wherein Tm is the melting temperature of the metallic powder in at least one layer of powder which is the main component. [81] The method according to any of [1] to [75], wherein the maximum temperature at which the powder bed is exposed in step 2 is less than 0.5*Tm, where Tm is the melting temperature in degrees Kelvin of the metallic powder in the powder bed with the highest melting point, said maximum temperature being below the sintering and melting temperature of the powder, to which Tm refers to. [82] The method according to any of [1] to [75], wherein the maximum temperature at which the powder bed is exposed in step 2 is less than 0.5*Tm, where Tm is the melting temperature in degrees Kelvin of the metallic powder in the powder bed with the lowest melting point, said maximum temperature being below the sintering and melting temperature of the powder, to which Tm refers to. [83] The method according to any of [1] to [75], wherein the maximum temperature at which the powder bed is exposed in step 2 is less than 0.5*Tm, where Tm is the melting temperature in degrees Kelvin of the metallic powder in the powder bed which is the main component, said maximum temperature being below the sintering and melting temperature of the powder, to which Tm refers to. [84] The method according to any of [1] to [75], wherein the maximum temperature at which the powder bed is exposed in step 2 is less than 0.5*Tm, where Tm is the melting temperature in degrees Kelvin of the metallic powder in at least one layer of powder which is the main component, said maximum temperature being below the sintering and melting temperature of the powder, to which Tm refers to. [85] The method according to [76], wherein Tm is the melting temperature in Kelvin of the ceramic powder in the powder bed with the highest melting point. [86] The method according to [76], wherein Tm is the melting temperature in degrees Kelvin of the ceramic powder in the powder bed with the lowest melting point. [87] The method according to [76], wherein Tm is the melting temperature in degrees Kelvin of the ceramic powder in the powder bed which is the main component. [88] The method according to [76], wherein Tm is the melting temperature of the ceramic powder in at least one layer of powder which is the main component. [89] The method according to any of [1] to [75], wherein the maximum temperature at which the powder bed is exposed in step 2 is less than 0.5*Tm, where Tm is the melting temperature in degrees Kelvin of the ceramic powder in the powder bed with the highest melting point, said maximum temperature being below the sintering and melting temperature of the powder, to which Tm refers to. [90] The method according to any of [1] to [75], wherein the maximum temperature at which the powder bed is exposed in step 2 is less than 0.5*Tm, where Tm is the melting temperature in degrees Kelvin of the ceramic powder in the powder bed with the lowest melting point, said maximum temperature being below the sintering and melting temperature of the powder, to which Tm refers to. [91] The method according to any of [1] to [75], wherein the maximum temperature at which the powder bed is exposed in step 2 is less than 0.5*Tm, where Tm is the melting temperature in degrees Kelvin of the ceramic powder in the powder bed which is the main component, said maximum temperature being below the sintering and melting temperature of the powder, to which Tm refers to. [92] The method according to any of [1] to [75], wherein the maximum temperature at which the powder bed is exposed in step 2 is less than 0.5*Tm, where Tm is the melting temperature of the ceramic powder in at least one layer of powder which is the main component, said maximum temperature being below the sintering and melting temperature of the powder, to which Tm refers to. [93] The method according to any of [1] to [92], wherein the powder bed further comprises a polymer. [94] The method according to [93], wherein the polymer is in liquid form. [95] The method according to [93], wherein the polymer is in powder form. [96] The method according to any of [1] to [95], wherein the powder bed comprises a polymer in an amount of less than 79% by volume in respect of the total volume of the powder bed, and a metallic and/or ceramic powder. [97] The method according to any of [1] to [96], wherein the maximum temperature at which the powder bed is exposed in step 2 is greater than 0.5*Tmp. [98] The method according to [97], wherein Tmp is the melting temperature in degrees Celsius of the polymer with the lowest melting point in the powder bed. [99] The method according to [97], wherein Tmp is the melting temperature in degrees Celsius of the polymer with the highest melting point in the powder bed. [100] The method according to [97], wherein Tmp is the melting temperature in degrees Celsius of the polymer in the powder bed which is the main polymeric component. [101] The method according to any of [1] to [96], wherein the maximum temperature at which the powder bed is exposed in step 2 is greater than 0.5*Tmp, where Tmp is the melting temperature in degrees Celsius of the polymer with the lowest melting point in the powder bed. [102] The method according to any of [1] to [96], wherein the maximum temperature at which the powder bed is exposed in step 2 is greater than 0.5*Tmp, where Tmp is the melting temperature in degrees Celsius of the polymer with the highest melting point in the powder bed. [103] The method according to any of [1] to [96], wherein the maximum temperature at which the powder bed is exposed in step 2 is greater than 0.5*Tmp, where Tmp is the melting temperature in degrees Celsius of the polymer in the powder bed which is the main polymeric component. [104] The method according to any of [1] to [96], wherein the maximum temperature at which the powder bed is exposed in step 2 is greater than 0.5*Ts. [105] The method according to [104], wherein Ts is the Vicat softening temperature in degrees Celsius of the polymer with the lowest Vicat softening temperature in the powder bed. [106] The method according to [104], wherein where Ts is the Vicat softening temperature in degrees Celsius of the polymer with the highest Vicat softening temperature in the powder bed. [107] The method according to [104], wherein Ts is the Vicat softening temperature in degrees Celsius of the polymer in the powder bed which is the main polymeric component. [108] The method according to any of [1] to [96], wherein the maximum temperature at which the powder bed is exposed in step 2 is greater than 0.5*Ts, where Ts is the Vicat softening temperature in degrees Celsius of the polymer with the lowest Vicat softening temperature in the powder bed. [109] The method according to any of [1] to [96], wherein the maximum temperature at which the powder bed is exposed in step 2 is greater than 0.5*Ts, where Ts is the Vicat softening temperature in degrees Celsius of the polymer with the highest Vicat softening temperature in the powder bed. [110] The method according to any of [1] to [96], wherein the maximum temperature at which the powder bed is exposed in step 2 is greater than 0.5*Ts, where Ts is the Vicat softening temperature in degrees Celsius of the polymer in the powder bed which is the main polymeric component. [111] The method according to any of [1] to [96], wherein the maximum temperature at which the powder bed is exposed in step 2 is greater than 0.5* HDT at 0.455 MPa. [112] The method according to [111], wherein HDT at 0.455 MPa is the heat deflection temperature measured with a load of 0.455 MPa in degrees Celsius of the polymer with the lowest HDT at 0.455 MPa in the powder bed. [113] The method according to [111], wherein HDT at 0.455 MPa is the heat deflection temperature measured with a load of 0.455 MPa in degrees Celsius of the polymer with the highest HDT at 0.455 MPa in the powder bed. [114] The method according to [111], wherein HDT at 0.455 MPa is the heat deflection temperature measured with a load of 0.455 MPa in degrees Celsius of the polymer in the powder bed which is the main polymeric component. [115] The method according to any of [1] to [96], wherein the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer with the lowest HDT at 0.455 MPa in the powder bed. [116] The method according to any of [1] to [96], wherein the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer with the highest HDT at 0.455 MPa in the powder bed. [117] The method according to any of [1] to [96], wherein the maximum temperature at which the powder bed is exposed in step 2 is greater than 0.5* HDT at 0.455 MPa, where HDT at 0.455 MPa is the heat deflection temperature measured with a load of 0.455 MPa in degrees Celsius of the polymer in the powder bed which is the main polymeric component. [118] The method according to any of [1] to [96], wherein the maximum temperature at which the powder bed is exposed in step 2 is greater than 0.5* HDT at 1.82 MPa. [119] The method according to [118], wherein HDT at 1.82 MPa is the heat deflection temperature measured with a load of 1.82 MPa in degrees Celsius of the polymer with the lowest HDT at 1.82 MPa in the powder bed. [120] The method according to [118], wherein HDT at 1.82 MPa is the heat deflection temperature measured with a load of 1.82 MPa in degrees Celsius of the polymer with the highest HDT at 1.82 MPa in the powder bed. [121] The method according to [118], wherein HDT at 1.82 MPa is the heat deflection temperature measured with a load of 1.82 MPa in degrees Celsius of the polymer in the powder bed which is the main polymeric component. [122] The method according to any of [1] to [96], wherein the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer with the lowest HDT at 1.82 MPa in the powder bed. [123] The method according to any of [1] to [96], wherein the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer with the highest HDT at 1.82 MPa in the powder bed. [124] The method according to any of [1] to [96], wherein the maximum temperature at which the powder bed is exposed in step 2 is greater than 0.5* HDT at 1.82 MPa, where HDT at 1.82 MPa is the heat deflection temperature measured with a load of 1.82 MPa in degrees Celsius of the polymer in the powder bed which is the main polymeric component. [125] The method according to any of [1] to [103], wherein the maximum temperature at which the powder bed is exposed in step 2 is less than 0.5*Tm and greater than 0.5*Tmp. [126] The method according to any of [1] to [103], wherein the maximum temperature at which the powder bed is exposed in step 2 is less than 0.5*Tm and greater than 0.5*Tmp, where Tm is the melting temperature in degrees Kelvin of the metallic powder in the powder bed with the highest melting point and Tmp is the melting temperature in degrees Celsius of the polymer high the lowest melting point in the powder bed. [127] The method according to any of [1] to [96] and [104] to [110], wherein the maximum temperature at which the powder bed is exposed in step 2 is less than 0.5*Tm and greater than 0.5*Ts. [128] The method according to any of [1] to [96] and [104] to [110], wherein the maximum temperature at which the powder bed is exposed in step 2 is less than 0.5*Tm and greater than 0.5*Ts, where Tm is the melting temperature in degrees Celsius of the metallic powder in the powder bed with the highest melting point and Ts is the Vicat softening temperature in degrees Celsius of the polymer high the lowest melting point in the powder bed. [129] The method according to any of [1] to [96] and [111] to [117], wherein the maximum temperature at which the powder bed is exposed in step 2 is less than 0.5*Tm and greater than 0.5* HDT at 0.455 MPa. [130] The method according to any of [1] to [96] and [111] to [117], wherein the maximum temperature at which the powder bed is exposed in step 2 is less than 0.5*Tm and greater than 0.5* HDT at 0.455 MPa, where Tm is the melting temperature in degrees Celsius of the metallic powder in the powder bed with the highest melting point and 0.5* HDT at 0.455 MPa HDT is the heat deflection temperature measured with a load of 0.455 MPa in degrees Celsius of the polymer with the lowest HDT at 1.82 MPa in the powder bed. [131] The method according to any of [1] to [96] and [118] to [124], wherein the maximum temperature at which the powder bed is exposed in step 2 is less than 0.5*Tm and greater than 0.5* HDT at 1.82 MPa. [132] The method according to any of [1] to [96] and [118] to [124], wherein the maximum temperature at which the powder bed is exposed in step 2 is less than 0.5*Tm and greater than 0.5* HDT at 1.82 MPa, where Tm is the melting temperature in degrees Celsius of the metallic powder in the powder bed with the highest melting point and 0.5* HDT at 1.82 MPa HDT is the heat deflection temperature measured with a load of 1.82 MPa in degrees Celsius of the polymer with the lowest HDT at 1.82 MPa in the powder bed. [133] The method according to any of [100] to [132], wherein the main polymeric component is the polymer with the highest weight percentage in the powder bed, wherein if there are two or more polymers with the same weight percentage that are the polymers with the highest weight percentage in the powder bed, then the main polymeric component is the polymer with the lowest melting temperature. [134] The method according to any of [100] to [132], wherein the main polymeric component is the polymer with the highest weight percentage in the powder bed, wherein if there are two or more polymers with the same weight percentage that are the polymers with the highest weight percentage in the powder bed, then the main polymeric component is the polymer with the lowest Vicat softening temperature. [135] The method according to any of [100] to [132], wherein the main polymeric component is the polymer with the highest volume percentage in the powder bed, wherein if there are two or more polymers with the same volume percentage that are the polymers with the highest volume percentage in the powder bed, then the main polymeric polymer is the polymer with the lowest melting temperature. [136] The method according to any of [100] to [132], wherein the main polymeric component is the polymer with the highest volume percentage in the powder bed, wherein if there are two or more polymers with the same volume percentage that are the polymers with the highest volume percentage in the powder bed, then the main polymeric component is the polymer with the lowest Vicat softening temperature. [137] The method according to any of [1] to [136], wherein the powder bed comprises at least a metal or metal alloy in powder form. [138] The method according to any of [1] to [137], wherein the powder bed comprises at least one of the following metals or metal alloys: iron, iron based alloy, steel, stainless steel, nickel, nickel based alloy, copper, copper based alloy, chromium, chromium based alloy, cobalt, cobalt based alloy, molybdenum, molybdenum based alloy, manganese, manganese based alloy, aluminium, aluminium based alloy, tungsten, tungsten based alloy, titanium, titanium based alloy, lithium, lithium based alloy, magnesium, magnesium based alloy, niobium, niobium based alloy, zirconium, zirconium based alloy, silicon, silicon based alloy, tin, tin based alloy, tantalum, tantalum based alloy, and/or mixtures thereof. [139] The method according to any of [1] to [138], wherein the powder bed comprises at least a ceramic material in powder form. [140] The method according to any of [1] to [139], wherein the powder bed comprises at least one of the following ceramic materials: boron, crystalline boron, borides, chromium boride (CrB), chromium diboride (CrB₂), titanium diboride (TiB₂), zirconium diboride (ZrB₂), magnesium diboride (MgB₂), niobium diboride (NbB₂), hafnium diboride (HfB₂), tantalum diboride (TaB₂), carbides, boron carbide (B₄C), chromium carbide (Cr₃C₂), molybdenum carbide (Mo₂C), silicon carbide (SiC), titanium carbide (TiC), tungsten titanium carbide (WTiC), vanadium carbide (VC), zirconium carbide (ZrC), hafnium carbide (HfC), tantalum carbide (TaC), niobium carbide (NbC), nitrides, aluminium nitride (AlN), boron nitride (BN), silicon nitride (Si₃N₄), titanium carbonitride (Ti (C, N), titanium nitride (TiN), zirconium nitride (ZrN), hafnium nitride (HfN), vanadium nitride (VN), tantalum nitride (TaN), niobium nitride (NbN) oxides, yttrium oxide (Y₂O₃), boron oxide (B₂O₃), zin oxide (ZnO), zirconium oxide (ZrO₂), silicon, silicides, molybdenum disilicide (MoSi₂), titanates, barium titanate (BaTiO₃), strontium titanate (SrTiO₃), lead zirconate, titanate (PZT), silicates, steatite, sialon, bioceramics, alumina, ferrite, porcelain, and/or mixtures thereof. [141] The method according to any of [1] to [140], wherein the powder bed comprises at least a polymer. [142] The method according to any of [1] to [141], wherein the powder bed comprises at least one of the following polymers: polyimide (PI), polycarbonate (PC), ether ketone (EK), polyethylene sulfide (PPS), polytetrafluorethylene (PTFE), polyethylene terephthalate (PET), polybutylene terephthalate (PBT), PA6, PA11, polyamide (PA), polyoxymethylene (POM), polymethylmethacrylate (PMMA), polystyrene (PS), acrylonitrile-butadiene-styrene (ABS), styrene-acrylonitrile (SAN), polypropylene (PP), polyethylene (PE), Polyamide-Imide (PAI), Polyethersulfone (PES), olyphenylsulfone (PPSU), polyetherimide (PEI), polysulfone (PSU), polyparaphenylene (PPP), polyether ether ketone (PEEK), polyetherketone (PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), PA6-3-T, PA46, polymethylpentene (PMP), polyphenylene ether (PPE), and/or mixtures thereof. [143] The method according to any of [1] to [142], wherein the powder bed comprises catalytic particles that raise their temperature when exposed to the radiation. [144] The method according to any of [1] to [143], wherein the method comprises the use of catalytic particles to absorb the radiation and to raise the temperature [145] The method according to any of [1] to [144], wherein the method comprises the use of catalytic particles to absorb the radiation and to raise the temperature of the powder bed, where they are located. [146] The method according to any of [1] to [145], wherein said method comprises the use of layers of polymer in liquid form instead of layers of powder. [147] The method according to [146], wherein the method comprises the steps of: Step 1: providing a polymer bed comprising at least one layer of polymer in liquid form; Step 2: exposing at least part of the polymer bed to radiation to cure only part of the polymer in the polymer bed; Step 3: optionally, providing an additional layer of polymer in liquid form adjacent to the previously cured or at least partially cured layer of polymer to form successive layers of the polymer bed; Step 4: optionally, repeating step 2; Step 5: optionally, repeating steps 3 and 4 until the component is completely additively manufactured; and Step 6: separating the cured or partially cured polymer from the uncured polymer in the polymer bed. [148] The method according to [147], wherein the polymer bed comprises catalytic particles to absorb the radiation and produce the curing of the polymer. [149] The method according to any of [1] to [148], wherein the polymer is mixed with ceramic and/or metallic particles to form a slurry. [150] The method according to any of [1] to [149], wherein the method comprises the use of layers of slurry instead layers of powder. [151] The method according to [150], wherein the method comprises the steps of: Step 1: providing a slurry bed comprising at least one layer of slurry; Step 2: exposing at least part of the polymer bed to radiation to cure only part of the layer of slurry in the slurry bed; Step 3: optionally, providing an additional layer of slurry adjacent to the previously cured or at least partially cured layer of slurry to form successive layers of the slurry bed; Step 4: optionally, repeating step 2; Step 5: optionally, repeating steps 3 and 4 until the component is completely additively manufactured; and Step 6: separating the cured or partially cured slurry from the uncured slurry in the slurry bed. [152] The method according to [151], wherein the slurry bed comprises catalytic particles to absorb the radiation and produce the curing of the slurry. [153] The method according to any of [1] to [145], wherein the voids between the particles in the powder bed have a right size. [154] The method according to any of [1] to [145], wherein the right size of the voids between the particles in the powder bed is a size between 60 nanometres and 980 microns. [155] The method according to any of [1] to [145], wherein the particles in the powder bed have a right size. [156] The method according to any of [153] to [155], wherein the size is the mean size. [157] The method according to any of [155] to [156], wherein the right size of the particles in the powder bed is a size between 60 nanometres and 980 microns. [158] The method according to any of [155] to [157], wherein the size of the particles refers to D50, which is the particle size at which 50% of the sample's volume is comprised of smaller particles in the cumulative distribution of particle size. [159] The method according to any of [155] to [157], wherein the size of the particles refers to D10, which is the particle size at which 10% of the sample's volume is comprised of smaller particles in the cumulative distribution of particle size. [160] The method according to any of [155] to [157], wherein the size of the particles refers to D90, which is the particle size at which 90% of the sample's volume is comprised of smaller particles in the cumulative distribution of particle size. [161] The method according to any of [1] to [145] and [154] to [160], wherein the size of the particles in the powder bed is between 0.98 e⁻⁶ and 4.8 times the length of the radiation wavelength. [162] The method according to any of [1] to [145] and [154] to [160], wherein the minimum size of the particles in the powder bed is 0.18 times or more the maximum size of the particles. [163] The method according to any of [1] to [145] and [154] to [162], wherein at least part of the particles in the powder bed are chosen with a value of parameter PTC of 11 or more, being the parameter PTC calculated using the formula: PTC=specific heat*density*thermal conductivity, wherein specific heat is given in J/(g*K), density is given in g/cm³, thermal conductivity is given in W/(m*K), and specific heat and thermal conductivity are at room temperature (23° C.). [164] The method according to [163], wherein at least part of the particles is 1.6% by volume or more of the particles. [165] The method according to any [1] to [145] and [154] to [164], wherein the radiation to which the powder bed is exposed in step 2 is a proper radiation. [166] The method according to any of [146] to [148], wherein the radiation to which the polymer bed is exposed in step 2 is a proper radiation. [167] The method according to any of [149] to [152], wherein the radiation to which the slurry bed is exposed in step 2 is a proper radiation. [168] The method according to any of [165] to [167], wherein the proper radiation comprises radiation in the microwave range. [169] The method according to any of [165] to [167], wherein the proper radiation is radiation in the microwave range. [170] The method according to any of [165] to [167], wherein the proper radiation is a radiation with a frequency of 2.45 GHZ +/−250 MHz. [171] The method according to any of [165] to [167], wherein the proper radiation is a radiation with a frequency of 5.8 GHz +/−1050 MHz. [172] The method according to any of [165] to [167], wherein the proper radiation is a radiation with a frequency of 915 MHz +/−250 MHz. [173] The method according to any of [165] to [167], wherein the proper radiation is a radiation with a frequency of 2.45 MHz +/−250 MHz. [174] The method according to any of [165] to [167], wherein the proper radiation comprises radiation in the THz range. [175] The method according to any of [165] to [167], wherein the proper radiation is radiation in the THz range. [176] The method according to any of [165] to [167], wherein the proper radiation is a radiation with a frequency between 0.0002 and 120 THz or less. [177] The method according to any of [165] to [167], wherein the proper radiation is a radiation with a frequency of 89 THz or less. [178] The method according to any of [165] to [167], wherein the proper radiation is a radiation with a frequency of 0.0012 THz or more. [179] The method according to any of [165] to [167], wherein the proper radiation is a radiation with a frequency of 0.2 THz or more. [180] The method according to any of [165] to [167], wherein the proper radiation is a radiation with a frequency of 1.1 THz or more. [181] The method according to any of [165] to [167], wherein the proper radiation is a radiation with a frequency of 120 THz or less. [182] The method according to any of [165] to [167], wherein the proper radiation is a radiation with a frequency of 89 THz or less. [183] The method according to any of [165] to [167], wherein the proper radiation is a radiation with a wavelength between 0.0006 and 19 cm. [184] The method according to any of [165] to [167], wherein the proper radiation is a non-ionizing radiation. [185] The method according to any of [165] to [167], wherein the proper radiation is coherent radiation. [186] The method according to any of [165] to [167], wherein the proper radiation is coherent radiation that can remain coherent even after the penetration into the powder bed. [187] The method according to any of [165] to [167], wherein the proper radiation is a free propagating radiation composed of one or more discrete wavelengths. [188] The method according to any of [165] to [167], wherein the proper radiation is a radiation with a mean photon quantum energy between 0.6 e⁻⁵ eV and 5.9 e⁻³ eV. [189] The method according to any of [165] to [167], wherein the proper radiation is applied using at least 2 radiation emitters. [190] The method according to any of [165] to [167], wherein the proper radiation is microwave radiation applied using at least 2 radiation emitters. [191] The method according to any of [165] to [167], wherein the proper radiation is applied using at least 2 different frequencies. [192] The method according to any of [165] to [167], wherein the proper radiation is applied using at least 2 radiation emitters at different frequencies. [193] The method according to any of [1] to [192], wherein said method is performed in a chamber. [194] The method according to any of [1] to [193], wherein said method comprises the use of at least 2 radiation emitters. [195] The method according to any of [1] to [194], wherein said method comprises the use of radiation emitters which are located in different parts of the chamber. [196] The method according to any of [193] to [195], wherein said method further comprises changing the volume of the chamber. [197] The method according to any of [1] to [196], wherein said method further comprises changing the position of the radiation source. [198] The method according to any of [189] to [197], wherein said method further comprises changing the position of the radiation emitters. [199] The method according to any of [1] to [198], wherein said method further comprises changing the frequency of the radiation. [200] The method according to any of [165] to [199], wherein the proper radiation is applied using at least two radiation emitters. [201] The method according to any of [165] to [200], wherein, the proper radiation is microwave radiation applied using at least two radiation emitters. [202] The method according to any of [165] to [201], wherein the proper radiation is applied using at least 2 different frequencies. [203] The method according to any of [165] to [202], wherein the proper radiation is applied using at least 2 radiation emitters at different frequencies. [204] The method according to any of [189] to [203], wherein the radiation emitters are located in different parts of the chamber. [205] The method according to any of [1] to [204], wherein the radiation irradiance is between 0.2 and 980 W/cm². [206] The method according to any of [1] to [205], wherein the radiation irradiance is applied into the powder bed as a 2D or 3D pattern. [207] The method according to any of [1] to [206], wherein the 3D radiation field is created through patterns of interference. [208] The method according to any of [1] to [207], wherein the radiation interference patterns are generated below the surface of the powder bed. [209] The method according to any of [165] to [208], wherein the proper radiation resonates in confined areas. [210] The method according to [209], wherein the effective volume in which resonance occurs is 89% or less of the irradiated volume in the powder bed. [211] The method according to any of [1] to [210], wherein said method further comprises the application of a magnetic field. [212] The method according to any of [1] to [211], wherein said method further comprises the application of a magnetic field orthogonal to the direction of propagation of the radiation. [213] The method according to any of [1] to [212], wherein said method further comprises the application of a magnetic field between 45° and 135° to the direction of propagation of the radiation. [214] The method according to any of [1] to [213], wherein said method further comprises the application of a magnetic field parallel to the direction of propagation of the radiation. [215] The method according to any of [1] to [214], wherein said method further comprises the application of a magnetic field between 30° and −30° to the direction of propagation of the radiation. [216] The method according to any of [1] to [215], wherein the radiation is the proper radiation. [217] The method according to any of [1] to [216], wherein said method is performed in a chamber pressurized with a fluid to 1200 bar or more. [218] The method according to any of [1] to [217], wherein the chamber is closed and sealed after introducing the powder. [219] The method according to any of [1] to [218], wherein said method comprises the use of at least one radiation generator. [220] The method according to any of [165] to [219], wherein the proper radiation is generated with a radiation generator. [221] The method according to any of [165] to [219], wherein the proper radiation is generated with a microwave generator. [222] The method according to any of [165] to [219], wherein the proper radiation is generated with a solid-state generator. [223] The method according to any of [165] to [219], wherein the proper radiation is generated with a solid-state microwave generator. [224] The method according to any of [1] to [223], wherein said method is performed using at least one radiation applicator per generator. [225] The method according to any of [1] to [224], wherein the total power of the generators employed is between 55 and 55000 W. [226] The method according to any of [1] to [225], wherein said method comprises the use of at least 2 applicators as the radiation source. [227] The method according to any of [1] to [226], wherein said method comprises the use of less than 990 applicators as the radiation source. [228] The method according to any of [1] to [227], wherein said method comprises the use of at least 2 microwave applicators as the radiation source. [229] The method according to any of [1] to [228], wherein said method comprises the use of less than 990 microwave applicators as the radiation source. [230] The method according to any of [165] to [229], wherein the proper radiation is applied using between 2 and 990 microwave applicators. [231] The method according to any of [224] to [230], wherein the applicator comprises an antenna. [232] The method according to any of [224] to [230], wherein the applicator is an antenna. [233] The method according to any of [1] to [232], wherein said method comprises the use of a radiation generator comprising more than 2 radiation applicators. [234] The method according to any of [1] to [233], wherein said method comprises the use of a radiation generator comprising less than 19 radiation applicators. [235] The method according to any of [224] to [234], wherein, the number of microwave applicators per generator is between 2 and 19. [236] The method according to any of [219] to [235], wherein the generator is located inside the chamber. [237] The method according to any of [219] to [235], wherein the generator is located outside of the chamber. [238] The method according to any of [219] to [237], wherein the generator is a magnetron. [239] The method according to any of [1] to [238], wherein said method is performed in a chamber which further comprises glowing materials applied to an element contained in the chamber. [240] The method according to [239], wherein the glowing materials are applied in powder form. [241] The method according to any of [239] to [240], wherein the glowing materials comprise at least a metal or an alloy. [242] A component manufactured according to the method of any of [1] to [241] [243] An apparatus for the additive manufacturing of components, in particular an apparatus for the volumetric printing of components through holograms, the apparatus comprising:—a chamber in which a three-dimensional component is additively manufactured;—a powder holder for holding a powder bed,—at least one radiation generator; and—at least one radiation applicator per generator; [244] The apparatus according to [243], wherein the chamber is closed and sealed after introducing the powder. [245] The apparatus according to any of [243] to [244], wherein the chamber is pressurized with a fluid to 1200 bar or more. [246] The apparatus according to any of [243] to [245], wherein the chamber has a cylindrical shape. [247] The apparatus according to any of [243] to [246], wherein said apparatus further comprises at least two radiation emitters. [248] The apparatus according to any of [243] to [247], wherein said apparatus further comprises at least two radiation emitters at different frequencies [249] The apparatus according to any of [243] to [248], wherein said apparatus further comprises at least two radiation emitters located in different geometrical areas of the chamber. [250] The apparatus according to any of [243] to [249], wherein the radiation source is mounted in a system that changes its position. [251] The apparatus according to any of [243] to [250], wherein said apparatus further comprises a mobile system. [252] The apparatus according to any of [243] to [251], wherein said apparatus comprises at least 1 radiation generator. [253] The apparatus according to any of [243] to [252], wherein said apparatus comprises at least one microwave generator. [254] The apparatus according to any of [243] to [253], wherein said apparatus comprises a solid-state generator. [255] The apparatus according to any of [243] to [254], wherein the total power of the generators employed is between 55 and 55000 W. [256] The apparatus according to any of [243] to [255], wherein the total power of the microwave generators employed is between 55 and 55000 W. [257] The apparatus according to any of [243] to [256], wherein said apparatus comprises more than 2 radiation applicators. [258] The apparatus according to any of [243] to [257], wherein said apparatus comprises less than 990 applicators. [259] The apparatus according to any of [243] to [258], wherein said apparatus comprises at least one microwave applicator. [260] The apparatus according to any of [243] to [259], wherein said apparatus comprises more than 2 microwave applicators. [261] The apparatus according to any of [243] to [260], wherein said apparatus comprises less than 990 microwave applicators. [262] The apparatus according to any of [243] to [261], wherein the applicator is a microwave applicator comprising an antenna. [263] The apparatus according to any of [243] to [262], wherein the microwave applicator is an antenna. [264] The apparatus according to any of [243] to [263], wherein said apparatus comprises at least 2 radiation applicators. [265] The apparatus according to any of [243] to [264], wherein the generator comprises less than 19 radiation applicators. [266] The apparatus according to any of [243] to [265], wherein the generator comprises at least 2 microwave applicators. [267] The apparatus according to any of [243] to [266], wherein the generator comprises less than 19 microwave applicators. [268] The apparatus according to any of [243] to [267], wherein the generator comprises less than 19 microwave applicators. [269] The apparatus according to any of [243] to [268], wherein the generator is located outside of the chamber. [270] The apparatus according to any of [243] to [269], wherein the generator is located inside the chamber. [271] The apparatus according to any of [243] to [270], wherein the generator is a magnetron. [272] The apparatus according to any of [243] to [271], wherein a high-pressure resistant magnetron is introduced into the chamber. [273] The apparatus according to any of [243] to [272], wherein only the antenna of the magnetron is introduced in the chamber. [274] The apparatus according to any of [243] to [273], wherein the connection between the anode of the magnetron and the antenna is interrupted with a feedthrough to enter the chamber, having the antenna in the high-pressure region and the rest of the magnetron outside. [275] The apparatus according to any of [243] to [274], wherein the generator is connected to a coaxial feedthrough in one of the walls of the chamber through a coaxial cable. [276] The apparatus according to any of [243] to [275], wherein the microwave generator is connected to a coaxial feedthrough in one of the walls of the chamber through a coaxial cable [277] The apparatus according to any of [243] to [276], wherein the coaxial cable has a nominal outer diameter (OD) of 7/32″ or greater. [278] The apparatus according to any of [243] to [277], wherein the coaxial feedthrough has a nominal outer diameter (OD) of 7/32″ or greater. [279] The apparatus according to any of [243] to [278], wherein the coaxial cable has an impedance of 199 Ohms or less. [280] The apparatus according to any of [243] to [279], wherein the coaxial feedthrough has an impedance of 199 Ohms or less. [281] The apparatus according to any of [243] to [280], wherein the chamber comprises more than 2 and less than 19 coaxial feedthrough entry points. [282] The apparatus according to any of [243] to [281], wherein said apparatus further comprises the use of an electric potential feedthrough of more than 600 V. [283] The apparatus according to any of [243] to [282], wherein said apparatus further comprises the use of an electric potential feedthrough of less than 190000 V. [284] The apparatus according to any of [243] to [283], wherein said apparatus further comprises the use of an apparent power feedthrough greater than 1200 V. [285] The apparatus according to any of [243] to [284], wherein said apparatus further comprises the use of an apparent power feedthrough of less than 990000 V. [286] The apparatus according to any of [243] to [285], wherein said apparatus further comprises the use of a high power feedthrough greater than 1100 W. [287] The apparatus according to any of [243] to [286], wherein said apparatus further comprises the use of a high power feedthrough of less than 890000 W. [288] The apparatus according to any of [243] to [287], wherein said apparatus comprises a radiation source mounted in a system that can be moved to generate the desired patterns. [289] The apparatus according to any of [243] to [288], wherein the movement is made in the horizontal and/or vertical plane. [290] The apparatus according to any of [243] to [289], wherein the movement is in more than one plane. [291] The apparatus according to any of [243] to [290], wherein the movement is rotational. [292] The apparatus according to any of [243] to [291], wherein said apparatus further comprises at least one element to reflect the radiation. [293] The apparatus according to any of [243] to [292], wherein said apparatus further comprises blades. [294] The apparatus according to any of [243] to [293], wherein the mobile system comprises blades. [295] The apparatus according to any of [243] to [294], wherein the mobile system comprises blades that reflect the radiation. [296] The apparatus according to any of [243] to [295], wherein the mobile system comprises blades that reflect the microwaves. [297] The apparatus according to any of [243] to [296], wherein the blades are made of metal. [298] The apparatus according to any of [243] to [297], wherein the blades are made of a polished metal sheet. [299] The apparatus according to any of [243] to [298], wherein said apparatus further comprises glowing elements which are applied to an element contained in the chamber. [300] The apparatus according to any of [243] to [299], wherein the glowing materials are applied in powder form. [301] The apparatus according to any of [243] to [300], wherein the glowing materials comprise at least a metal or an alloy. [302] The apparatus according to any of [243] to [301], wherein the radiation applicator, the generator and/or the antenna are located inside the element supporting the glowing materials. [303] The apparatus according to any of [243] to [302], wherein said apparatus further comprises at least 1 radiation shield. [304] The apparatus according to any of [243] to [303], wherein said apparatus further comprises at less than 99 radiation shields. [305] The apparatus according to any of [243] to [304], wherein the radiation shield is made of a material comprising a metallic alloy. [306] The apparatus according to any of [243] to [305], wherein said apparatus further comprises a system for changing the dimensions of the chamber. [307] The apparatus according to any of [243] to [306], wherein said apparatus further comprises a radiation shield. [308] The apparatus according to any of [243] to [307], wherein the radiation is the proper radiation. [309] Use of the apparatus according to any of [243] to [308] to perform the method according to any of [1] to [241].

Throughout this document, unless otherwise stated, the use of terms such as “below”, “above”, “or more”, “from”, “to”, “up to”, “at least”, “greater than”, “less than”, “more than” and the like, refers to ranges that may be subsequently broken down into sub-ranges and combined with other upper and/or lower limits disclosed in any combination, provided that they are not mutually exclusive.

Throughout this document, expressions like “method for the additive manufacturing”, “method for three-dimensional printing”, “method for 3D printing”, “method for the manufacture” and “method for the volumetric printing”may be used interchangeably.

Throughout this document, expressions like “additively manufactured”, “printed”, “manufactured”, “built up” and their variants may be used interchangeably.

Throughout this document, expressions like “field strength”, “field intensity”, and their variants may be used interchangeably.

Throughout this document, what has been disclosed in relation to the powder bed may, in certain embodiments, also apply to at least one of the layers of powder in the powder bed and/or to at least one of the layers of powder provided.

### Some Test Conditions Are As Follows.

The HDT test conditions which may be employed to determine deflection temperature measured according to ASTM D648-07 standard test method with a load of 0.455 MPa [66 psi] or 1.82 MPa [264 psi] are disclosed below.

Heat deflection temperature is measured in an automated apparatus, with silicon oil as liquid heat-transfer medium up to 250° C., for higher temperatures graphite powder is employed as heat-transfer medium (and a thermocouple calibrated according to ASTM E2846-14 instead a thermometer for temperature measurement) 3 specimens are used of 3 mm width according to ASTM D648-07 Method A, with loads of 0.455 MPa [0.66 psi] or 1.82 MPa [264 psi], the load used is indicated for each measure. Prior to the analysis test specimens and bath are equilibrated at 30° C., heating rate is 2° C./min. Test specimens are obtained according to molding methods A to C disclosed below. When a specimen can be obtained by more than one molding method (A to C), the specimen obtained by each method is tested and the highest value obtained is the value selected of heat deflection temperature.

Preparation of test specimens: the mold used to obtain the test specimen for heat deflection temperature is 127 mm in length, 13 mm when HDT is measured according to ISO 75-1:2013 Method B test with a load of 0.455 MPa or 1.82 MPa (the load used is indicated for each measure).

### Molding Methods:

Molding method A. Photopolymerization is carried using a photo-initiator. Photo-initiator (type, percentage) is selected in accordance with the recommendations of the supplier. If not provided, the photo-initiator used is Benzoyl peroxide, 2 wt %. A mold with the required dimensions in function the specimen required is filled with a homogeneous mixture between the resin and the photo-initiator. The mixture is polymerized according to the cured conditions provided by the supplier (wavelength, and time of exposure), if not provided the material is cured under UV lamp (365 nm, 6 W) for 2 h. After this time the specimen is removed from the mold and the bottom part is also cured in the same conditions as upper part. The cure is carried out in a closed light insulating box, where only the radiation of the lamp incident in the specimen, which is 10 cm away from the light source.

Molding method B. Thermoforming is carried in a conventional thermoforming machine, the required amount of material to obtain 3 mm in thickness is clamped in the frame of the mold. Once the material sheet is secured in the heating area, it is heated to forming temperature, which is selected in accordance with the supplier recommendations, if not provided, temperature selected is 20° C. below the glass transition temperature (Tg). Once specimen is in the mold, is cooled to 25° C. The excess material to obtain the required specimen is removed.

Molding method C. Injection molding is carried in a conventional injection molding machine. Plastics pellets are selected as raw material when available, if not the different chemical components are injected into the barrel. The material is heated up the temperature and during the time recommended by the supplier, if not provided, the material is heated to a temperature 10° C. above their melting temperature and maintained for 5 minutes (when the degradation point of the material is more than 50° C. higher than the melting temperature) or 20° C. above the glass transition temperature (Tg) of the material (if the degradation point is less than 50° C. higher than the melting temperature).

Glass transition temperature (Tg) may be measured by differential scanning calorimetry (DSC) according to ASTM D3418-12. Weight of the sample 10 mg. In a ceramic container. Purge gas used argon (99.9%) at flow rate 25 ml/min. Heating/cooling rates 10° C./min. For liquid polymers or resins, after pulverization the sample is polymerized according to molding methods A to C disclosed below to obtain a test specimen, and then the sample is pulverized. When a specimen can be obtained by more than one molding method (A to C), the specimen obtained by each method is tested and the highest value obtained is the value selected of Tg.

All the embodiments disclosed throughout this document can be combined among them in any combination, provided that they are not mutually exclusive.

Further embodiments of the present disclosure can be found in the examples and in the claims.

### EXAMPLE 1

An experimental setup was built to measure field intensity in different locations and to measure temperatures developed in a powder bed. Some of the relevant constituents of the setup were:
Chamber: several shapes mostly cubic and cylindrical from 0.1 m³ to 40 m³. Most of them build with stainless steel sheet but also other materials (one 100% lead and also one TiGr5 sheet).
Waveguides and even coaxial feed-troughs.
Generators: 1× nano plasma switch technology (600 mW), 5× solid-state electronics sources (100, 140, 200, 300 and 600 GHz) up to 1.5 W, borrowed VED sources up to 2.5 KW peak and (100 to 10000 GHZ), 6-18 GHz up to 0.5 KW solid-state microwave generator, 8 MHz-2.2 GHz up to 0.7 KW solid-state RF/Microwave generator. Several L-band microwave generators up to 5 KW. Very many s-band microwave generators up to 20 KW. A few C-band microwave generators up to 2.5 KW and even a couple X-band generators.
Applicators: Several antenna/applicator shapes. Mounted in several places of the chamber. Also, a controlled position turning table with 100 applicators (but the maximum waveguides/feedthroughs in a given chamber was 50).
Movable Blades: Maximum 4 concentric blades.
Movable reflector-shields: upper and lower shield, also a configuration with pie-shields moving independently of each other with a maximum stacking of 4.

Rotating/raising table: controlled position rotating table to control/change the position of the powder bed. Table can also be raised/lowered to change the volume of the chamber and vertical position of powder bed.

Mostly the setup was used to understand the coupling groups of several control variables present, calibrate the simulation package (as presented in another example) and execute the design of experiments for the supervised learning of the Machine Learning system used in some of the other examples summarized in this document (most of the training was done with field intensity maps obtained through the properly calibrated simulation by means of using the setup described here). Some demonstration experiments to advance in the TRL levels and proofs of concept were also carried out.

In a first approach to understand some plausible executions of layered printing of components a layer-on-top powder-bed system constructed with materials with high transparency to both THz and microwave radiation was built and introduced in the experimental setup to conduct the same experiments but layer by layer (the system was a traditional roller-system with a dispenser to supply the powder and a roller to homogeneously distribute it). This system allowed to apply layers from 25 microns to 5 mm. To test thinner layers a modification on the roller was made but the thickness homogeneity was somewhat lower than normal. Tests were executed to layers with a mean thickness somewhat lower than a micron using nano metric powder but there were some challenges with electrostatic charging of the powder explaining some deviation of the results from the ones expected. For thicker layers, several layers were applied with the roller system and treated as one layer in terms of exposition to the radiation. Layers thicker than 0.5 m were tested. The system allowed to test different strategies for the proper inter-layer bonding of components, test conditions less susceptible to diffraction since the system had some variations in the filling density of each layer, etc. Then also different ways were explored to decouple the already manufactured component with its corresponding powder bed from the “new” layer being manufactured by means of reflectors and even more interestingly high wavelength radiation stoppers (in particular some configurations with metal slab terminated high wavelength one-way waveguides leading to extremely enhanced magnetic fields). It was seen that conditions can be reached to efficiently decouple at least part of the already processed material and surrounding powder bed, making the amount of usable potential holograms (combinations of control variables) much higher and thus allowing for a much shorter sequence of holograms to attain the desired components shape. Also a model was also implemented to keep track of at which points in time every given point in the powder bed was exposed to a field strength higher than a certain level (the level that was determined in every experiment as the limit for high field strength consideration) so that any point, or subset of points, could be compared amongst each other in terms of when in every point in time they had a higher/lower/potentially similar field strength and then the actual field strength values were automatically retrieved to evaluate how significant the differences were.

In this system the behaviors were studied for different powder beds (metallic powders, ceramic powders, polymeric powders, also composites with each one of the bases: metal matrix, ceramic matrix and polymer matrix, and mixtures). The system was also of great help to determine the effectiveness of multiple “glowing particles” as consolidation enhancers. A lot of work was done in the use of low temperature consolidation. For example polymeric material was either used as admired powder or even the main (metallic, ceramic, . . . ) powder was coated with polymer and the consolidation behavior studied with or without the usage of different “glowing particles”. Also, a VAT was constructed to be able to study the polymerization of liquid polymers and slurries (mixtures of liquid polymers with powder particles: metallic, ceramic even polymeric, composites and mixtures) also the efficiency of many initiators and terminators was tested. The system was also used to evaluate the degree of reliability at each training stage of the Machine Learning system by applying the resulting control variable sequences and comparing the obtained components and lack of consolidation in the remaining powder bed/VAT.

It is also worth mentioning that a few tests were done with pre-heating of the powder material at a temperature slightly below sintering/melting and then using the induced temperature rise by the exposition to high electromagnetic field strength to induce sintering/melting in the points exposed to high field strength. As general observations: * It is easier to implement in polymers than ceramics, especially in polymers with a re-solidification temperature well below the melting temperature; * effective “glowing particles” help a lot; * refractory metals are very challenging.

### EXAMPLE 2

With the setup of example 1, and advanced simulation tool based on Ansys HFSS was fine tuned to precisely simulate the electromagnetic field strength at every point within the chamber and in particular at every point within the powder bed in the setup as a function of all control variables (all tun-able or adjustable parameters/features in the setup of example 1). With the help of the setup several simulations were run and afterwards tested in the setup to validate the simulation package.

In FIG. 4 a) two slices of a plane within the powder bed are shown where the electromagnetic field intensity is represented by means of a colour scale, each slice corresponds to a different combination of control variables values.

Once the simulation package was fine tuned, it was employed for the formal learning of a machine learning system, where the scalar output was the electromagnetic field strength map of the powder bed (electromagnetic field strength at every point of the powder bed in the chamber of the setup of example 1) and the input vector comprised the value of each control variable. Input vector clustering (grouping of all vectors leading to the same output) was used to help the transformation inversion. The system was employed for almost all materials described in example 1, and in a first approach a pulse length was chosen for each material which corresponded to the pulse length leading to consolidation under a continuous exposition to an electromagnetic field intensity of 650 V/m, which was different for each material. In a first approach the machine learning system was employed to determine a sequence of holograms (electromagnetic field strength maps) comprising points with electromagnetic field strengths above 650 V/m only within the component to be manufactured (amongst others, a 20×60×110 mm coupon, a hot stamping die insert, a die casting coupon and a 60×80×140 mm block with void letters inside) and having an electromagnetic field strength below 320 V/m for all points not coinciding with component to be manufactured. The minimum number of holograms was selected by the system whose superposition covered all points of the components to be manufactured, furthermore the different holograms where sequenced using as a criteria minimum changes in control variables from one hologram to the next in the sequence. The sequence was executed maintaining each hologram during the determined pulse length in the setup of example one. In the first experiments the radiation was stopped when transitioning from one hologram to the next (changing the corresponding control variable values). Then some tests were done without turning off the radiation when transitioning from one hologram to the next and trying to speed up as much as possible such transition. At this point, tests were executed to evaluate, pulse time and maximum time between pulses for strategies requiring two or more expositions (holograms lighting the point of interest by assuring an electromagnetic field strength above 650 V/m but below 850 V/m) within a certain time. The first try-outs the pulse time was reduced by a 35% and all points coinciding with components to be manufactured were lit at least twice within half a minute and most points not coinciding with a component to be manufactured were not lit at all, while other points were lit only once and a few were lit twice but with more than 15 minutes between lightings. The results were positive. Then other combinations of pulse time reduction were tested and also a combination of strategies with different holograms having different pulse times were tested.

At that point, Simulation of the behaviour of Microwave and THz wave stoppers was carried out (see FIG. 4 b) and validated with the setup of example one. Validation proved much more challenging than originally anticipated, so that it was only possible to work with wave stoppers in a limited way.

Finally, a successful attempt was made at providing with the machine learning system a continuous variation of the process variables to consolidate the points and only the points coinciding with components to be manufactured. For this approach the machine learning system had to trained with a different approach, the scalar output was changed to a consolidation map in the powder bed (degree of consolidation of every point in the powder bed. To estimate the value of consolidation a model to account for consolidation (from 0% to 100%) was developed:

C(x,y,z,tₙ)=f[Electric field strength (x,y,z), Thermal conductivity tensor (x,y,z), Thermal conductivity of the point (x,y,z), C(x,y,z,tₙ₋₁), Temperature (x,y,z)]. After the transformation inversion the system was used to provide the shortest possible sequence of changes in control variables leading to 100% consolidation at some point in time for all points coinciding with component to be manufactured and less than 50% consolidation at all times in the other points of the powder bed. The optimized sequence of variation of control variables can also be rationalized in terms of hologram sequence and comparing holograms between them, subsets of points with similar or significant difference in each hologram and how such relation varies when moving from one hologram to the next, although in the case of continuous variation the amount of holograms cannot be counted, they still exist. In such scenarios follow up of point subsets can be more practicable.

### EXAMPLE 3

As mentioned a VAT for liquid polymer was built for the setup of Example one and several tests were carried out to see advantages and disadvantages of using different slurry densities, from mostly liquid polymer slightly charged slurries to close to theoretical TAP density of metallic/ceramic/polymeric powder particles and then filling the voids with little viscosity polymerizable resin and even the case where the particles where only coated with the liquid polymer and then placed in the VAT (liquid polymer bed). Tests were carried out with most materials of example one and all materials of examples 4 to 6. Many polymerization initiators and terminators were tested with very considerable differences in the performance. From all hundredths of combinations that worked well for each material class, one has random been picked to describe here:
Just liquid polymer & polymer particles: for this material class one working combination was the use of liquid styrene with Azobisisobutyronitrile as a polymerization initiator. Same system worked also well when PEEK powder particles were added.
Ceramic: for this material class one working example consisted in using Barium titanate particles as “glowing particles” for thermal initiated polymerization resins where the main powder of the component was partially stabilized zirconia powder.
Metal: for this material class one working example consisted in using SiC as “glowing particles” for several thermal initiated polymerization resins where the main powder of the component was an Aluminum alloy powder. The SiC particles were very effective and afterwards remained in the final component providing very enhanced wear resistance.

### EXAMPLE 4

Using the setup of example 1 and the machine learning of example 2, a segment of a hot stamping die and a HPDC sub-insert were produced. In this case very complex cooling strategies were employed to fully capitalize the freedom of design of the technology. Not only were the cooling systems conformal but also the cross section was optimized for maximum heat exchange under a RE of 12000 (square cross-section with rounded edges). In this case High Thermal Conductivity Tool Steel powder according to WO2008/017341 but with lower % C than required. Then the powder was admixed with polyethylene (PE) powder and porous carbon particles (which acted as powerful “glowing particles” and also ended up contributing with the missing % C in the steel powder during the diffusion heat treatment after consolidation and debinding. In this case the particle size of the steel powder was 10-20 microns and the PE 250-400 microns. Radiation wavelength was constrained between 1.1 and 10 THz. Looking at the first hologram (H0), the hologram after exactly 6 minutes of processing (H6) and the hologram after exactly 12 minutes of processing (H12) all points in the powder bed could be classified in 22 subsets (A to V): Subset A: Points which had roughly the same field strength values in all 3 holograms (H0, H6, H12) (Here there were 3 noticeable subsets: a1) The field strength value was above the threshold set as “high field strength” leading to consolidation, a2) field strength below but close to the threshold and a3) low values of field strength); Subset B: Points which had substantially higher field strength (>) in the first hologram (H0), and roughly the same (=) in the other two (H6, H12); Subset C: Points which had substantially higher field strength (>) in the first two holograms (H0, H6), and roughly the same (=) in the last one (H12); Subset D: Points which had substantially higher field strength (>) in the first hologram (H0), roughly the same (=) in the second hologram (H6) and substantially higher field strength (>) in the last hologram (H12) [from this point on this will be described as H0>/H6=/H12>]; Subset E: H0=/H6=/H12>; Subset F: H0=/H6>/H12=; Subset G: H0</H6=/H12=; Subset H: H0</H6</H12=; Subset I: H0</H6=/H12<; Subset J: H0=/H6=/H12<; Subset K: H0=/H6</H12=; Subset L: H0>/H6</H12<; Subset M: H0>/H6>/H12<; Subset N: H0>/H6</H12>; Subset O: H0</H6</H12>; Subset P: H0</H6>/H12<; Subset Q: H0>/H6</H12=; Subset R: H0>/H6=/H12<; Subset S: H0</H6=/H12>; Subset T: H0</H6>/H12=; Subset U: H0=/H6>/H12<and Subset V: H0=/H6</H12>; the same exercise was done comparing 4 holograms and up to more than 10 for which the number of subsets is quite huge but most subsets are rather irrelevant and only those which change and change reversals are more interesting. The HPDC sub-insert was manufactured in just one layer by filling the whole powder bed with powder from the beginning. In the case of the hot stamping die, it was fabricated in a layered fashion. For the areas without cooling channels a layer thickness of 20 mm was chosen and the areas with cooling channels a layer of 0.5 mm was chosen. Particular care was taken working with wave-stoppers and all other means to constrain the consolidation only to the actual layer and the one before (just last 2 layers) the consolidation, for the 20 mm layers, while for the 0.5 mm layers particular care was taken to constrain the consolidation to the last 10 applied layers. All process variables available in the setup of example 1 were employed and changed within the processing.

In the case of the HPDC sub-insert, the powder bed was tempered to 95° C. and it was observed that temperatures reached in points where consolidation was desired ranged from 150° C. and 230° C., while the temperature of points where consolidation was not desired remained always below 103° C.

In the case of the Hot Stamping insert, the powder bed was not tempered and it was observed that temperatures reached in points where consolidation was desired ranged from 140° C. and 280° C., while the temperature of points where consolidation was not desired remained always below 87° C.

### EXAMPLE 5

Some small electric isolators were manufactured with the setup of example 1. The parts were manufactured in Alumina. The powder distribution system for layered manufacturing of the setup was used and charged with a mixture of Alumina powder particles (60%) and PP (polypropylene) copolymer powder particles (40%). After some try-outs with powder bed tempering and without, the final components were manufactured with a powder bed tempering of 127° C. The PP copolymer presented a HDT at 1.8 MPa according to ASTM D648 of 51° C. Temperatures reached in points where consolidation was desired ranged from 178° C. and 230° C. After separation from the loose powder, the parts were subjected to various pressure and temperature treatments including CIP, WIP, HIP and sintering. In most cases also an additional debinding treatment was employed. (Those treatment combinations were also tested for coupons manufactured with the materials employed in examples 3 and 4 and several materials described in example 1).

### EXAMPLE 6

Some prototypes were printed in the setup of example 1. The prototypes were manufactured using different types of oleofin powders (PP, PE, PA, HDPE) both homopolymers and copolymers were tested with different additives. In some cases, “glowing particles” were employed (like carbon black, porous carbon, SiC, BaTiO3, etc) but in most cases the consolidation was made without the help of glowing particles. In this case, the opportunity was taken to experiment with a broad range of radiation wavelengths and thus all available generators were plugged in at least one of the emitters. The wavelength at disposal was 8 MHz to 10000 GHz, but the machine learning system of example 2 only chose values from 800 MHz and 2000 GHz for the frequency control variables for each emitter. The same exercise as in example 4 was done in terms of comparing holograms at different points in time amongst them. In this case, the hologram after 3 minutes of processing (H3) after 7 minutes (H7) and after 11 minutes (H11) were chosen and several scenarios studied, by means of choosing different voxel shapes and sizes to define the different points in the powder bed, including the case that each powder particle represents a point (case in example 4), it was seen that the different subset classification coincides with the one described in example 4 but the size of each subset was different. In some cases, the powder bed was tempered using temperatures from 40 to 200° C. Temperatures reached in points where consolidation was desired ranged from 110° C. and 350° C., while the temperature of points where consolidation was not desired remained always below 60° C. when processing PE and HDPE, 72° C. when processing PP and 140° C. when processing PA. In most cases the melting temperature was reached for the points were consolidation was desirable, but in some tests temperature at the points were consolidation was desired was kept between the sintering temperature and the melting temperature, finally in some cases partial bonding/consolidation was used by limiting the temperature reached in the points where consolidation was desirable below the sintering temperature of the material, in such cases the mechanical properties of the final components were rather poor, with some exceptions, but enough for the prototyping purpose.

1. A method for the additive manufacturing of components, in particular a method for the volumetric printing of components through holograms, comprising the following steps:
Step 1: providing a powder bed comprising at least one layer of powder;
Step 2: exposing at least part of the powder bed to radiation to consolidate only part of the powder in the powder bed;
Step 3: optionally, providing an additional layer of powder adjacent to the previously consolidated or at least partially consolidated layer of powder to form successive powder layers of the powder bed;
Step 4: optionally, repeating step 2;
Step 5: optionally, repeating steps 3 and 4 until the component is completely additively manufactured; and
Step 6: separating the consolidated or partially consolidated powder from the unconsolidated powder in the powder bed.

2. The method according to claim 1, wherein there are points in the powder bed which are exposed to a higher radiation field strength than other points in the powder bed at least at one point in time in step 2.

3. The method according to claim 1, wherein at a first point in time in step 2, there is a first subset of points in the powder bed which is exposed to a substantially higher radiation field strength than a second subset of points in the powder bed;
and wherein at a second point in time in step 2, the second subset of points in the powder bed is exposed to a substantially higher radiation field strength than the first subset of points in the powder bed.

4. The method according to claim 1, wherein at a first point in time in step 2, there are a first and a second subset of points in the powder bed which are exposed to a substantially higher radiation field strength than a third subset of points in the powder bed; and wherein at a second point in time in step 2, the second and third subset of points in the powder bed are exposed to a substantially higher radiation field strength than the first subset of points in the powder bed.

5. The method according to claim 1, wherein at a first point in time in step 2, there is a first subset of points in the powder bed which is exposed to a substantially higher radiation field strength than a second subset of points in the powder bed; and wherein at a second point in time in step 2, there is no significant difference between the radiation field strength to which the first and second subset of points are exposed.

6. The method according to claim 1, wherein at a first point in time in step 2, there is a first subset of points in the powder bed which is exposed to a substantially higher radiation field strength than a second subset of points in the powder bed;
wherein at a second point in time in step 2, there is no significant difference between the radiation field strength to which the first and second subset of points are exposed; and wherein at a third point in time in step 2, the second subset of points in the powder bed is exposed to a substantially higher radiation field strength than the first subset of points in the powder bed.

7. The method according to claim 1, wherein at a first point in time in step 2, there is a first subset of points in the powder bed which is exposed to a substantially higher radiation field strength than a second subset of points in the powder bed;
wherein at a second point in time in step 2, there is no significant difference in the radiation field strength to which the first and second subset of points are exposed; wherein at a third point in time in step 2, the second subset of points in the powder bed is exposed to a substantially higher radiation field strength than the first subset of points in the powder bed; and wherein at a fourth point in time in step 2, the first subset of points in the powder bed is exposed to a substantially higher radiation field strength than the second subset of points in the powder bed.

8. The method according to claim 7, wherein the second point in time is later than the first point in time, wherein the third point in time is later than the second point in time, and wherein the fourth point in time is later than the third point in time.

9. (canceled)

10. (canceled)

11. The method according to claim 1, wherein the radiation comprises electromagnetic radiation.

12. The method according to claim 7, wherein the points of each subset of points are not in every case adjacent to each other.

13. (canceled)

14. (canceled)

15. The method according to claim 7, wherein each point is a voxel, and wherein the voxel is a polyhedron with cubic geometry and an edge length of 0.001 mm.

16. (canceled)

17. The method according to claim 7, wherein at a first point in time in step 2, there is a first subset of points in the powder bed which is exposed to a radiation field strength that is 26% or more higher than a second subset of points in the powder bed: wherein at a second point in time in step 2, any difference in the radiation field strength to which the first and second subset of points are exposed is 19% or less; wherein at a third point in time in step 2, the second subset of points in the powder bed is exposed to a radiation field strength that is 26% or more higher than the first subset of points in the powder bed; and wherein at a fourth point in time in step 2, the first subset of points in the powder bed is exposed to a radiation field strength that is 26% or more higher than the second subset of points in the powder bed.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The method according to claim 1, wherein the radiation to which the powder bed is exposed in step 2 is a proper radiation, and wherein the proper radiation is a radiation with a frequency between 0.0002 and 120 THz or less.

40. The method according to claim 1, wherein the radiation to which the powder bed is exposed in step 2 is a proper radiation, and wherein the proper radiation is applied using at least 2 radiation emitters.

41. The method according to claim 1, wherein the radiation to which the powder bed is exposed in step 2 is a proper radiation, and wherein the proper radiation is applied using at least 2 different frequencies.

42. (canceled)

43. The method according to claim 1, wherein said method comprises the use of a sequence of holograms and the use of machine learning to generate the sequence of control variables which generates the sequence of holograms.

44. The method according to claim 1, wherein said method comprises the use of a sequence of holograms and the use of machine learning trained with a transformation from the input vector, containing all the possible combinations of the control variables and the scalar output, which is the radiation field intensity map comprising the value for each point in the powder bed, to generate the sequence of values for each control variable that generates the sequence of holograms.

45. The method according to any of claim 1, wherein said method comprises the use of a sequence of holograms and the use of machine learning trained with a transformation from the input vector, containing all the possible combinations of the control variables and the scalar output, which is the degree of consolidation map comprising the value for each point in the powder bed, to generate the sequence of values for each control variable that generates the sequence of holograms.

46. (canceled)

47. (canceled)

48. A method for the additive manufacturing of components, in particular a method for the volumetric printing of components through holograms, comprising the following steps:
Step 1: providing a slurry bed comprising at least one layer of slurry;
Step 2: exposing at least part of the polymer bed to radiation to cure only part of the layer of slurry in the slurry bed;
Step 3: optionally, providing an additional layer of slurry adjacent to the previously cured or at least partially cured layer of slurry to form successive layers of the slurry bed;
Step 4: optionally, repeating step 2;
Step 5: optionally, repeating steps 3 and 4 until the component is completely additively manufactured; and
Step 6: separating the cured or partially cured slurry from the uncured slurry in the slurry bed.

49. (canceled)

50. An apparatus for the additive manufacturing of components, in particular an apparatus for the volumetric printing of components through holograms, the apparatus comprising:
a chamber in which a three-dimensional component is additively manufactured;
a powder holder for holding a powder bed,
at least one radiation generator; and
at least one radiation applicator per generator.
